(19) United States
(12) Patent Application Publication
(10) Pub. No.: US 2009/0086035 A1
(43) Pub. Date: Apr. 2, 2009

(54) Vibration isolating unit, image taking unit, and image taking apparatus

(75) Inventors: Yusuke Suzuki, Saitama (JP); Akio Omiya, Saitama (JP); Yukio Noguchi, Saitama (JP); Yuichi Kawanabe, Saitama (JP); Naoko Takatori, Miyagi (JP); Yoshihiro Ishikawa, Miyagi (JP); Yokichi Goda, Miyagi (JP)

Correspondence Address: BIRCH STEWART KOLASCH & BIRCH, PO BOX 747, FALLS CHURCH, VA, 22040-0747, US

(73) Assignee: FUJINON CORPORATION

(21) Appl. No.: 12/230,158

(22) Filed: Aug. 25, 2008

(30) Foreign Application Priority Data
Sep. 28, 2007 (JP) 2007-256322

(51) Int. Cl. H04N 5/228; H04N 5/225

(52) U.S. Cl. 348/208.5; 348/340; 348/E05.031; 348/E05.024

(57) ABSTRACT

Y-driving section is disposed in X-direction of an image sensor holder, and a slider is arranged for the image sensor holder to come in succession to Z-direction and extend to X-direction, so that X-driving section is disposed at the end of the slider. Regarding Y-direction, Y-driving section directly drives the image sensor holder. Regarding X-direction, X-driving section drives the slider and indirectly drives the image sensor holder in X-direction.

### BACKGROUND OF THE INVENTION

1. Field of the Invention

The present invention relates to a vibration isolating unit for correcting blurring on an image, an image taking unit having the vibration isolating unit, and an image taking apparatus having the image taking unit.

2. Description of the Related Art

Recently, in an image taking apparatus, there is one which incorporates therein a vibration isolating mechanism to suppress a disturbance of a photographic image caused by camera shake of a user and the like. According to the vibration isolating mechanism, optical components such as a correction lens and an image sensor are movably disposed in a plane perpendicular to an optical axis. A correction of the camera shake is carried out when the correction lens or the image sensor are driven in accordance with the camera shake. Japanese Patent document 1 (Japanese Patent Application Laid Open Gazette TokuKai Hei. 3-186825), Japanese Patent document 2 (Japanese Patent Application Laid Open Gazette TokuKai 2006-215095) and Japanese Patent document 4 (Japanese Patent Application Laid Open Gazette TokuKai 2006-243704) disclose a technology in which the correction lens of the optical components is moved. Japanese Patent document 3 (Japanese Patent Application Laid Open Gazette TokuKai 2005-242325) disclose a technology in which the image sensor of the optical components is moved. According to technologies disclosed in Japanese Patent document 1 to Japanese Patent document 4, X driving section and Y driving section having each a voice coil motor are disposed along two axes which are perpendicular to one another in a plane including the correction lens or the image sensor, that is, X axis and Y axis, respectively, so that the X driving section and the Y driving section can quickly move the correction lens and the image sensor in X axis direction and Y axis direction, respectively.

Incidentally, in recent digital camera, as disclosed in Japanese Patent document 4 (Japanese Patent Application Laid Open Gazette TokuKai 2006-243704), there is frequent such a case that miniaturization and reducing the thickness of the body are implemented by installing a bending optical system wherein a subject light, which is incident along a first optical axis extending Y-direction forward the subject, is reflected to a direction along a second optical axis extending Z-direction perpendicular to Y-direction so as to make image-formation.

Even if it is intended to contributing to miniaturization and reducing the thickness of the body by using the above-mentioned bending optical system, some structure of a vibration isolating mechanism may disturb miniaturization and reducing the thickness of the body due to the vibration isolating mechanism.

### SUMMARY OF THE INVENTION

In view of the foregoing, it is an object of the present invention to provide a vibration isolating unit which is preferably installed in a digital camera contributing to miniaturization and reducing the thickness of the body by the use of the bending optical system, an image taking unit having the vibration isolating unit, and an image taking apparatus having the image taking unit.

To achieve the above-mentioned objects, the present invention provides a vibration isolating unit that is coupled with a lens-barrel unit including a bending optical system which turns a subject light incident along a first optical axis extending in Y-direction toward the subject to a direction along a second optical axis extending in Z-direction perpendicular to Y-direction so as to make image-formation, and that includes an image sensor for creating an image signal representing the subject through image-formation of the subject light by the bending optical system and moves the image sensor so that the vibration isolating unit suppresses blurring on the image signal, the vibration isolating unit including:

a vibration isolating unit holder which is a case of the vibration isolating unit;

a slider that has a first guide axis supported by the vibration isolating unit holder, the first guide axis being extended in a first direction which is one of the Y-direction and X-direction perpendicular to both Y-direction and Z-direction, the slider being freely movable in the first direction;

an image sensor holder that holds the image sensor and has a second guide axis supported by the slider, the second guide axis being extended in a second direction which is another different from the first direction, of the X-direction and the Y-direction, the image sensor holder being freely movable in the second direction;

a second driving section that moves the image sensor holder in the second direction, the second driving section being disposed at a place aligned in the X-direction with the image sensor holder; and

a first driving section that moves the slider together with the image sensor holder in the first direction, the first driving section being disposed at a place aligned in the X-direction with the second driving section.

According to the vibration isolating unit of the present invention as mentioned above, the slider is disposed along the X axis of the image sensor holder, so that the first driving section, which drives the slider, is disposed at a place aligned in the X-direction of the second driving section that directly drives the image sensor holder.

In other words, the first driving section and the second driving section are disposed in parallel at a place aligned in the X-direction of the image sensor holder. This feature makes it possible to reduce the size of the image sensor of the vibration isolating unit in Y-direction (that is, the thickness direction of the digital camera), so that the vibration isolating unit can be suitably accommodated in the digital camera which contributes to miniaturization and thinness.

In the vibration isolating unit according to the present invention as mentioned above, it is preferable that the first driving section has a first magnet and a first coil board on which there is formed a first coil that generates a driving force to drive the slider in the first direction by interaction with the first magnet upon receipt of a supply of power supply, and

the second driving section has a second magnet and a second coil board on which there is formed a second coil that generates a driving force to drive the image sensor holder in the second direction by interaction with the second magnet upon receipt of a supply of power supply.

This feature makes it possible to use a voice coil motor, which comprises the magnet and the coil board, as a driving source for individual driving section of the vibration isolating unit of the present invention.

In the vibration isolating unit according to the present invention as mentioned above, it is preferable that the first coil board and the second coil board are arranged so as to be perpendicular to one another.

This feature makes it possible to become easy for neither the first coil board CL1 nor the second coil board CL2 to receive electromagnetic interference mutually.

To achieve the above-mentioned objects, the present invention provides an image taking that has a lens-barrel unit including a bending optical system wherein a subject light incident along a first optical axis extending in Y-direction toward the subject to a direction along a second optical axis extending in Z-direction perpendicular to Y-direction so as to make image-formation, and that has a vibration isolating unit including an image sensor for creating an image signal representing the subject through image-formation of the subject light by the bending optical system and moves the image sensor so that the vibration isolating unit suppresses blurring on the image signal, wherein the vibration isolating unit includes:

a vibration isolating unit holder which is a case of the vibration isolating unit;

a slider that has a first guide axis supported by the vibration isolating unit holder, the first guide axis being extended in a first direction which is one of the Y-direction and X-direction perpendicular to both Y-direction and Z-direction, the slider being freely movable in the first direction;

an image sensor holder that holds the image sensor and has a second guide axis supported by the slider, the second guide axis being extended in a second direction which is another different from the first direction, of the X-direction and the Y-direction, the image sensor holder being freely movable in the second direction;

a second driving section that moves the image sensor holder in the second direction, the second driving section being disposed at a place aligned in the X-direction with the image sensor holder; and

a first driving section that moves the slider together with the image sensor holder in the first direction, the first driving section being disposed at a place aligned in the X-direction with the second driving section.

To achieve the above-mentioned objects, the present invention provides an image taking apparatus having the image taking unit as defined in claim 4, wherein the image taking apparatus generates an image signal in which blurring is reduced by operation of the vibration isolating unit constituting the image taking unit.

### BRIEF DESCRIPTION OF THE DRAWINGS

FIG. 1 is a perspective view of a digital camera 1 to which an embodiment of the present invention is applied.

FIG. 2 is an exploded view of a lens-barrel unit 10 installed in the digital camera 1 shown in FIG. 1.

FIG. 3 is an exploded view of a vibration isolating unit 11 installed in the digital camera 1 shown in FIG. 1.

FIG. 4 is a view showing an image taking unit 1A referred to in the present invention wherein a lens-barrel unit holder UH and a vibration isolating unit holder UH2 are coupled with one another via a sheet metal member 114.

FIG. 5 is a sectional view of the image taking unit 1A of FIG. 4 where the image taking unit 1A is cut along the direction of Z with a line parallel to the direction of X to view the cut plane from the front.

FIG. 6 is an extraction view wherein portions involved in a second lens group L2, a fifth lens group L5, and a zoom motor ZM, and portions involved in a fourth lens group L4 and a focus motor FM.

FIG. 7 is an explanatory view useful for understanding a structure of a coupling section for coupling the lens-barrel unit holder and the vibration isolating unit.

FIG. 8 is a perspective view wherein the state after the vibration isolating unit 11 is built is viewed from the upper side.

FIG. 9 is a view wherein the vibration isolating unit holder UH2, which is a case member of the vibration isolating unit 11, and a spring member 115, which is included in the vibration isolating unit holder UH2, are removed to view the inside of the vibration isolating unit 11.

FIG. 10 is a sectional view of the vibration isolating unit 11 of FIG. 8 where the vibration isolating unit 11 is cut along the direction of Z with a line parallel to the direction of X to view the cut plane from the front.

FIG. 11 is a view showing an arrangement of X-driving section 116A and Y-driving section 116B.

FIG. 12 is a view showing the structure of the Y-driving section.

FIG. 13 is an explanatory view useful for understanding a difference between the X-driving section and the Y-driving section in a direction of a coil board.

FIG. 14 is an explanatory view useful for understanding a difference between the X-driving section and the Y-driving section in a direction of a coil board.

FIG. 15 is an explanatory view useful for understanding a difference between the X-driving section and the Y-driving section in a direction of a coil board.

FIG. 16 is an explanatory view useful for understanding a structure of the sheet metal member 114.

FIG. 17 is a perspective view of the image taking unit 1A, wherein the lens-barrel unit holder UH and a vibration isolating unit holder UH2 are coupled with one another via the sheet metal member 114, looking from the upper side.

FIG. 18 is a front elevation of the image taking unit 1A of FIG. 17.

FIG. 19 is a rear elevation of the image taking unit 1A of FIG. 17.

FIG. 20 is a view showing the state that CCD is mounted on an image sensor holder.

FIG. 21 is an explanatory view useful for understanding the state that CCD is mounted on the image sensor holder.

FIG. 22 is a perspective view of the image sensor holder which mounts CCD.

FIG. 23 is a view showing the structure of the substrate that incorporates therein CCD and CCD.

FIG. 24 is an explanatory view useful for understanding the state of adhesion that is performed from the back of CCD, after CCD is mounted on the image sensor holder as shown in FIG. 20.

FIG. 25 is an explanatory view useful for understanding another structure of the vibration isolating unit.

### DETAILED DESCRIPTION OF PREFERRED EMBODIMENTS

Embodiments of the present invention will be described with reference to the accompanying drawings.

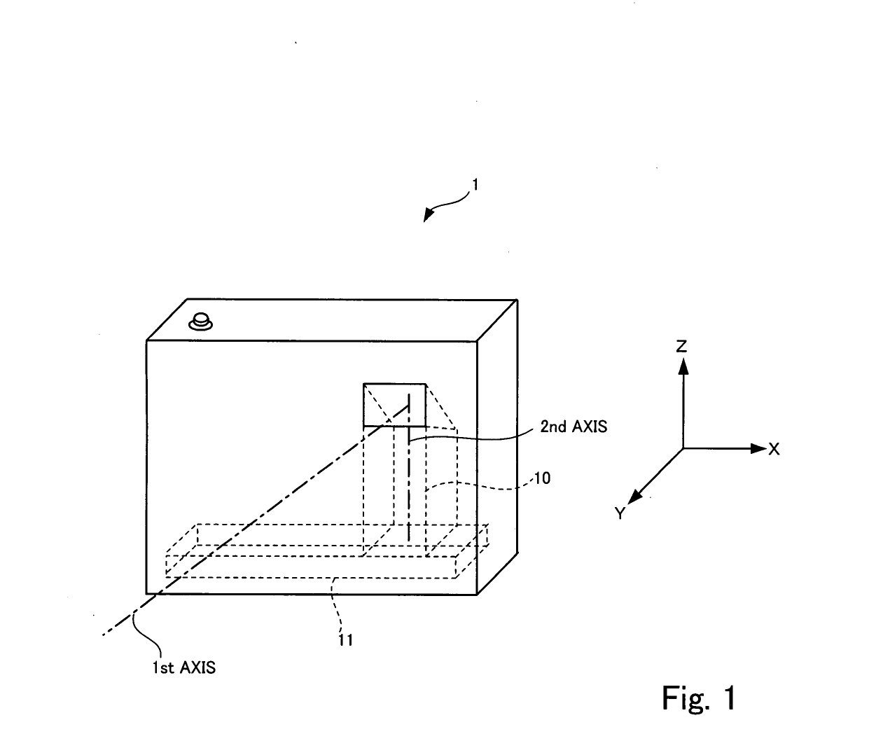

FIG. 1 is a perspective view of a digital camera 1 to which an embodiment of the present invention is applied.

FIG. 1 shows a perspective view of the digital camera 1 which adopts a lens-barrel unit 10 incorporating a bending optical system to contribute to miniaturization and reducing the thickness of the body of the digital camera 1.

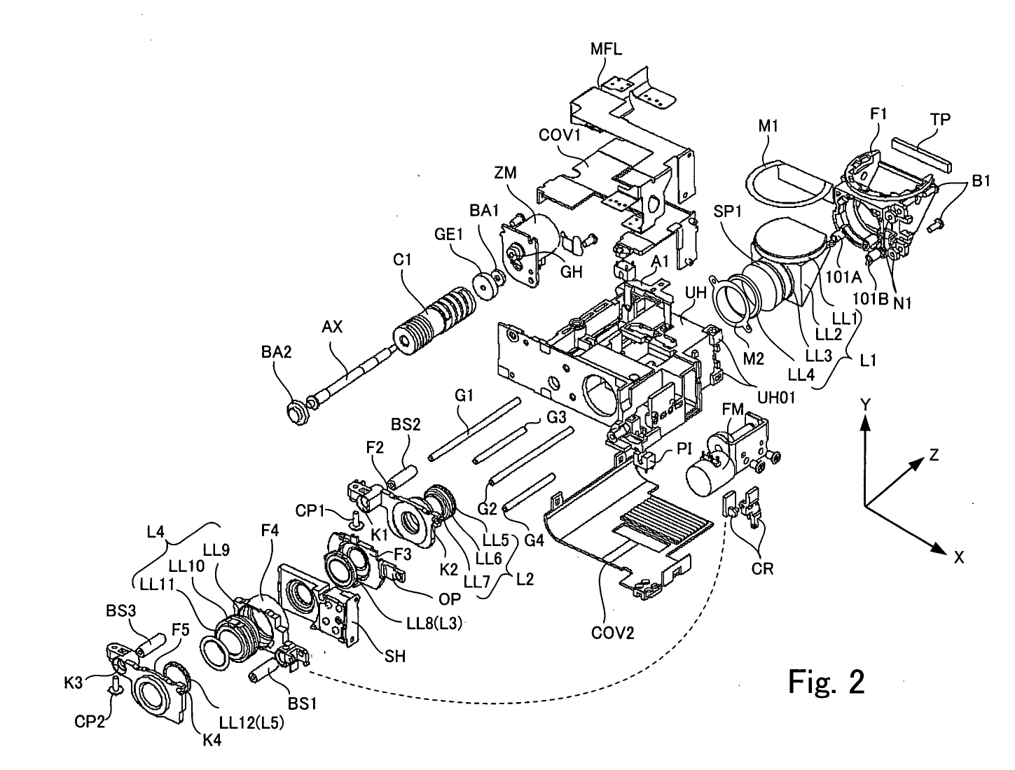

Since FIG. 1 shows a three-dimensional perspective view, FIG. 1 shows the axes of coordinates that represent X axis, Y axis, and Z axis to make the direction of X, the direction of Y, and the direction of Z used in the following explanations comprehensible. To indicate the direction in figures following FIG. 2 too, all the axes of coordinates are shown in the figures.

In the preferred embodiments of FIG. 1 to FIG. 24 which will be described hereinafter, there will be shown examples in which the direction of X represented by the above-mentioned axis of coordinates denotes the first direction referred to in the present invention, and the direction of Y represented by the above-mentioned axis of coordinates denotes the second direction referred to in the present invention. Therefore, according to the preferred embodiments of FIG. 1 to FIG. 24, an example of the first driving section referred to in the present invention corresponds to X driving section, and an example of the second driving section referred to in the present invention corresponds to Y driving section. Moreover, an example of the first guide axis referred to in the present invention corresponds to X guide axis, and an example of the second guide axis referred to in the present invention corresponds to Y guide axis.

The lens-barrel unit 10 of FIG. 1 incorporates therein a bending optical system wherein a subject light, which is incident along a first optical axis extending Y-direction forward the subject, is reflected to a direction along a second optical axis extending Z-direction perpendicular to Y-direction so as to make image-formation.

Although details will be described later, according to the present embodiment, as seen from FIG. 1, there is adopted an arrangement in which a vibration isolating unit 11 is coupled with the lens-barrel unit 10 incorporating a bending optical system, and there is prepared an image sensor for creating an image signal representing of the subject through image-formation of the subject light by the bending optical system, wherein the vibration isolating unit 11, which suppresses blurring on the image signal by moving the image sensor, is disposed under the lens-barrel unit 10. This feature makes it possible to contribute to shortening the length of the direction of Z and the direction of Y of the body of the digital camera.

In addition, according to the present embodiment, in view of the fact that the image sensor is very expensive, it is permitted to recycle by detaching the image sensor when the image sensor can be used when defective assembly and the like occur.

It explains the lens-barrel unit 10 of the lens-barrel unit and the vibration isolating unit referring to FIG. 2 first of all.

FIG. 2 is an exploded view of the lens-barrel unit 10 installed in the digital camera 1 shown in FIG. 1.

It explains individual members constituting the lens-barrel unit 10 referring to the lens-barrel unit 10 of FIG. 2 first of all.

Since the lens-barrel unit 10 incorporates therein a bending optical system having 5-group lens structure, individual lens groups are distinguished in such a manner that signs L1, L2, L3, L4, and L5 are applied to individual lens groups, respectively. The second lens group L2 and fifth lens group L5 of 5-group lens structure constitute a zoom lens. The fourth lens group L4 constitutes a focus lens. The first lens group L1 consists of three lenses LL1, LL3, LL4, and prism LL2, and the second lens group L2 consists of three lenses LL5, LL6, and LL7. Moreover, the third lens group L3 that is a fixed lens consists of one lens, and the fourth lens group that is the focus lens consists of three lenses LL9, LL10, and LL11. In addition, the fifth lens group L5 that composes the zoom lens with the second lens group L2 consists of one lens LL12.

It explains the structure of the lens-barrel unit 10 referring to FIG. 2.

First, there will be explained the structure of the first lens group L1 of 5-group lens structure.

At the upper right of FIG. 2, there is shown 1-group frame F1 for holding the first lens group L1 which comprises three lenses LL1, LL3, and LL4, and prism LL2. At the incident side, to which the subject light enters, of the prism LL2 that composes a part of the first lens group L1, there is prepared the lens LL1 exposed to surface. At the emission side wherein the subject light is emitted from the prism LL2, there are prepared two lenses. Those lenses are inserted into the 1-group frame F1. When the first lens group L1 is installed in 1-group frame F1, the first lens group L1 is fixed to 1-group frame F1 on a bonding basis. Afterwards, mask members M1 and M2 are set. An interval ring SP1 of FIG. 2 is inserted between the lens LL3 and the lens LL4.

At the lower left of FIG. 2, there is shown the lens-barrel unit holder UH which 1-group frame F1 is coupled with and accommodates the second lens group L2 to the fifth lens group L5.

When 1-group frame F1 is coupled with the lens-barrel unit holder UH, it is necessary to adjust the inclination of an optical axis. Accordingly, there is provided such an arrangement that a coupling section of 1-group frame F1 with the lens-barrel unit holder UH is provided with pull springs 101A and 101B, so that 1-group frame F1 is coupled with the lens-barrel unit holder UH by enabling the pull springs 101A and 101B. Machine screws B1 and B1 are engaged with nuts N1 and N1 on a spiral basis. The point portions of the machine screws B1 and B1 are in contact with projection portions UH01 and UH01 of the lens-barrel unit holder UH, respectively. Movement of the machine screw B1 and B1 makes it possible to adjust the interval between 1-group frame F1 and the lens-barrel unit holder UH.

Next, there will be briefly explained as to how the second lens group L2 and the fifth lens group L5 that compose the zoom lens, the fourth lens group L4 that composes the focus lens, and the third lens group L3 that is the fixed lens, are incorporated into the lens-barrel unit holder UH.

First, the third lens group L3, which is the fixed lens, is installed by a suppression board A1 in a holder wall of the lens-barrel unit holder UH together with 3-group frame F3, so that third lens group L3 is incorporated into the lens-barrel unit holder UH. The 3-group frame F3 is provided with an operating piece OP for adjusting a position of XY plane. The operating piece OP is installed in the lens-barrel unit holder UH while possible to be operated from the outside.

Moreover, the second lens group L2 and the fifth lens group L5, which compose the zoom lens via the third lens group L3, are built in the lens-barrel unit holder UH on a movable basis together with the several members that compose the zoom mechanism. Here, it easily explains the composition about the members that compose the zoom mechanism.

2-group frame F2 for holding the second lens group L2 of the second lens group L2 and the fifth lens group L5 that composes the zoom lens is provided with engagement sections K1 and K2 for engaging a cam pin CP1 with 2 guide shafts G1 and G2, respectively. 5-group frame F5 for holding the fifth lens group L5 is provided with engagement sections K3 and K4 for engaging a cam pin CP2 with two guide shafts G3 and G4, respectively.

Those cam pins CP1 and CP2 engage with a cylindrical cam C1 connected with a zoom motor ZM, and in addition the engagement sections K1, K2, K3, and K4 engage with the guide shafts G1, G2, G3, and G4 each that is supported by the lens-barrel unit holder UH and is set along Z axis, respectively, so that the second lens group L2 and the fifth lens group L5 are built in the lens-barrel unit holder UH on a movable basis along the Z axis. Bushes BS1 to BS3 are inserted into axis surroundings of an engagement section of the guide shaft G1 with the engagement section K1 of 2-group frame F2, an engagement section of the guide shaft G1 with the engagement section K3 of 5-group frame F5, and an engagement section of the guide shafts G4 with 4-group frame F4 which will be described later, respectively.

On the other hand, at the side of a gear head GH of a zoom motor ZM, there is prepared a zoom cam bearing BA1 made a free rotation of the other edge of a zoom cam axis AX described later, and deceleration gear GE1 is connected with the gear head GH of the zoom motor ZM. To penetrate through a center hole of the deceleration gear GE1 and a center hole of the cylindrical cam C1, a zoom cam axis AX is inserted, and the other edge of the zoom cam axis AX is connected with the zoom cam bearing BA1. The zoom mechanism in the state that the cylindrical cam C1 is connected with the zoom motor ZM is set on the lens group of 5 group composition and it is built in the lens-barrel unit holder UH. Because the point of the side opposite to the deceleration gear GE1 side of zoom cam axis AX comes to connect with a zoom cam bearing BA2 disposed in the lens-barrel unit holder UH and to rotate free, the focal length is adjusted by an adjustment of the mutual interval between the second lens group L2 and the fifth lens group L5, wherein the cam pins CP1 and CP2, which are prepared for 2-group frame F2 for holding the second lens group L2 and 5-group frame F5 for holding the fifth lens group L5, respectively, move in accordance with rotation of the cylindrical cam C1.

Although details will be described later, in order to contribute to shortening length of the lens-barrel unit in z-direction, there is provided such an arrangement in which an image sensor is disposed in the vibration isolating unit to drive the image sensor. In addition, in order to contribute to shortening a total length of one including the vibration isolating unit and the lens-barrel unit in z-direction, there is provided such an arrangement in which the fifth lens group L5 of the lens-barrel unit holder UH projects from the lens-barrel unit holder UH to the side of the vibration isolating unit and enters a receipt section at the side of the vibration isolating unit.

In the manner as mentioned above, the second lens group L2 and the fifth lens group L5, which constitute the zoom lens, are built in the lens-barrel unit holder UH together with the zoom mechanism.

Next, it explains the focus adjustment mechanism built in with the fourth lens group L4 that is the focus lens.

A focus carriage CR, which is engaged with the lead screw (not illustrated) extended from the focus motor FM, is coupled with 4-group frame F4 of the fourth lens group L4 that is the focus lens. Therefore, the fourth lens group L4 that is the focus lens moves in such a manner that the lead screw rotates in accordance with rotation of the focus motor FM, and the focus carriage CR moves on the lead screw along the second optical axis (direction of Z). Moreover, because the detection of the position of the fourth lens group L4 that is the focus lens when the focus lens is moved is necessary, a photo-interrupter PI to detect the position of the fourth lens group L4 that is the focus lens is disposed in the lens-barrel unit holder UH.

Further, according to the present embodiment, a mechanical shutter SH is built in between the fourth lens group L4 that is the focus lens and the third lens group L3 that is the fixed lens.

Thus, after the lens groups L2-L5 up to the second-fifth are built in respectively in the lens-barrel unit holder UH, 1-group frame F1 and the lens-barrel unit holder UH are concluded by the pull spring 101A and 101B. The machine screws B1 and B1 are respectively engaged on a spiral basis with the nuts N1 and N1 which are adhered with the adhesive to the 1-group frame F1 beforehand, and the machine screws B1 and B1 are moved, so that 1-group frame F1 is positioned to the lens-barrel unit holder UH by movement of the machine screws B1 and B1.

In addition, a cover COV2 is covered with a pre-cover COV1 and the lens-barrel unit 10 is built. A main flexible substrate MFL for the wiring set to cover the surface of the cover is shown in FIG. 2.

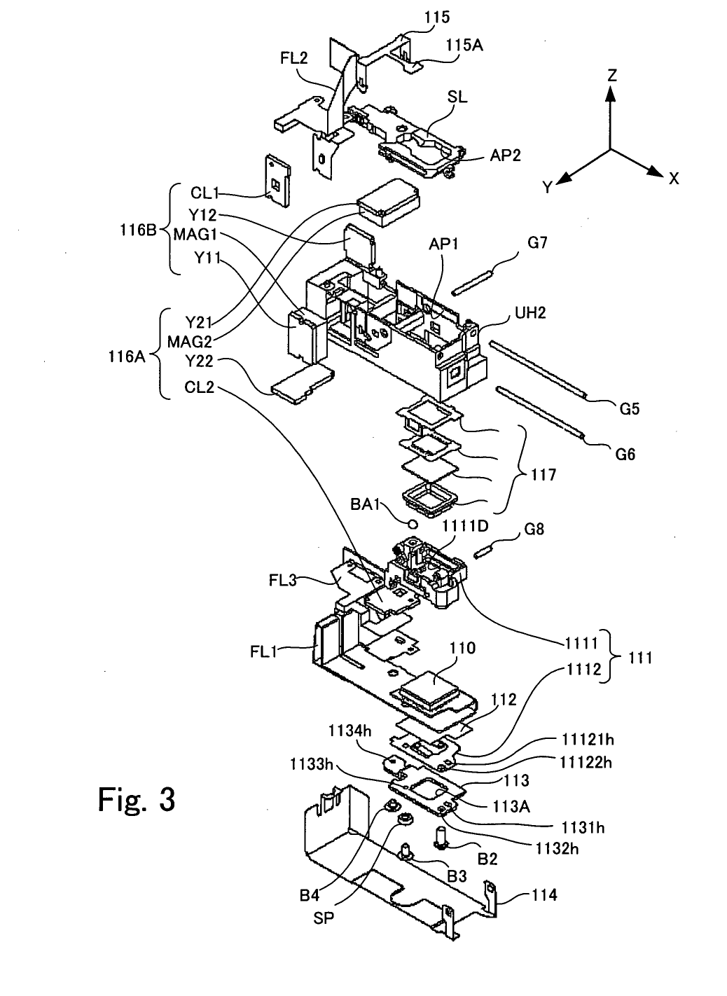

It explains the composition of the vibration isolating unit 11 to be connected to the lens-barrel unit 10 referring to FIG. 3 next.

FIG. 3 is an exploded view of a vibration isolating unit 11 installed in the digital camera 1 shown in FIG. 1.

The vibration isolating unit 11 of FIG. 3 suppresses blurring on the image signal in combination with the lens-barrel unit 10 shown in FIG. 2 by moving the image sensor 110 (it is referred to CCD hereinafter, since CCD solid-state image sensor here) that generates an image signal representative of the subject through the image-formation of the subject light by the bending optical system of the lens-barrel unit 10.

At the upper center of FIG. 3, there is shown the vibration isolating unit holder UH2 that is a cover member of the vibration isolating unit 11. The vibration isolating unit holder UH2 incorporates therein an image sensor holder 111, Y-driving section 116A for moving the image sensor holder 111 in Y-direction, a slider SL that supports the image sensor holder 111 on a slidable basis in Y-direction and moves the image sensor holder 111 in X-direction, and X-driving section 116B for moving the slider SL in X-direction together with the image sensor holder 111. The slider SL for moving the image sensor holder 111 in X-direction is disposed at the upper side of the image sensor holder 111 (direction of Z) and at the position near the vibration isolating unit holder UH2 (refer to FIG. 2) in such a manner that the slider is arranged for the image sensor holder 111 to come in succession to the second optical axis, in other words, the direction of Z and set along the direction of X.

According to the present embodiment, as mentioned above, in order to contribute to shortening the length of the direction of Z and the direction of Y of the body of the digital camera, the device is given to the structure of the vibration isolating unit holder UH2. Therefore, the structure of the vibration isolating unit holder UH2 will be explained hereinafter.

First, there will he explained the structure to contribute to shortening the size of the direction of Z.

As explained in FIG. 2, the fifth lens group L5 is projected from the lens-barrel unit holder UH to the vibration isolating unit holder UH2 side. Accordingly, the vibration isolating unit holder UH2 at the vibration isolating unit side and the slider SL are provided with apertures for accepting the fifth lens group L5 respectively.

As shown in FIG. 3, the vibration isolating unit holder UH2 has at the side of the lens-barrel unit 10 an aperture AP1 extending in such a manner that the slider SL directly faces the lens-barrel unit 10. The slider SL has an aperture AP2, which is disposed at the side of the lens-barrel unit 10 rather than the image sensor holder 111, that accepts a portion projecting from the lens-barrel unit holder UH (refer to FIG. 2) of the optical components (here the fifth lens group L5), which constitutes the bending optical system. Thus, when the fifth lens group L5 of the lens-barrel unit 10 side moves at the time of a variable power to the side of the image sensor with such an arrangement that the bottom of the lens-barrel unit holder UH is in contact with the top of F unit UH2, the fifth lens group L5 enters the aperture AP2 of the slider SL. This feature makes it possible to reduce the size of the lens-barrel unit 10 and the vibration isolating unit 11 in direction of Z.

The slider SL of FIG. 3 is supported by two X guide axes G5 and G6 which are extended in X-direction perpendicular to both Y-direction and Z-direction and are fixed on the vibration isolating unit holder UH2 on a press fitting basis, and is freely movable in X-direction. The image sensor holder 111 has two Y guide axes G7 and G8 which are extended in Y-direction and supported by the slider SL, and is freely movable in Y-direction together with Y guide axes G7 and G8. The image sensor holder 111 is provided with an image sensor holder main body 1111 having a front applying surface to which a light acceptance side front edge section of CCD 110 is applied, and a spring member 1112 that elastically urges the CCD back side, which is shown under the image sensor holder main body 1111. Moreover, the image sensor holder 111 has a CCD plate 113 that is disposed at the back side of CCD 110 to fix the spring member 1112 on the image sensor holder main body 1111, the CCD plate 113 being provided with an aperture exposing a pressing portion of the back side of the CCD 110. The CCD plate 113 is provided with an aperture 113A that exposes the spring member 1112 to the surface.

Under FIG. 3, there is shown a sheet metal member 114 for coupling the lens-barrel unit 10 with the vibration isolating unit 11. According to the present embodiment, as mentioned above, in order to contribute to reducing the length in direction of Z wherein the lens-barrel unit 10 is coupled with the vibration isolating unit 11, there is used the sheet metal member 114 which fits to the surface of the vibration isolating unit holder UH2 so that the lens-barrel unit 10 is coupled with to the vibration isolating unit 11. The use of the sheet metal member 114 needs no use of the fastening member such as the screws. This feature makes it possible to further shorten the size in the direction of Z.

Next, there will be explained how the device is given to the structure of the vibration isolating unit 11 in order to contribute to shortening the length of the direction of Y.

According to the present embodiment, the Y-driving section 116A for moving the image sensor holder 111 in Y-direction is disposed in direction of X, and the X-driving section 116B for moving the slider SL in X-direction together with the image sensor holder 111 is disposed at the position in parallel to X-direction of the Y-driving section 116A. This feature makes it possible to shorten the size in the direction of Y.

The X-driving section 116B has a first magnet MAG 1 and a first coil board CL1 on which there is formed a first coil that generates, upon receipt of a supply of power supply, power to drive the slider SL in direction of X by interaction with the first magnet MAG1. The Y-driving section 116A has a second magnet MAG 2 and a second coil board CL2 on which there is formed a second coil that generates, upon receipt of a supply of power supply, power to drive the image sensor holder 111 in direction of Y by interaction with the second magnet MAG2. Both the driving sections 116A and 116B are provided with two yokes Y11 and Y12, and two yokes Y21 and Y22 to reduce the leakage flux, respectively.

According to the present embodiment, in order to prevent the electromagnetic interference between the first coil board CL1 and the second coil board CL2, there is provided such an arrangement that one of the first coil board CL1 and the second coil board CL2, that is, the coil board CL1 for instance is directed to the direction of Y, and the other coil board CL2 is directed to the direction of Z.

Thus, an arrangement of the X-driving section 116B and the Y-driving section 116A in the direction of X needs no arrangement of the X-driving section 116B in the direction of Y of the image sensor holder 111. This feature makes it possible to shorten the size in the direction of Y as compared with the conventional ones.

Next, there will be explained how the device is given to contribute to recycling of CCD 110.

As mentioned above, according to the present embodiment, in view of the fact that CCD 110 that is the image sensor is very expensive, it is permitted to recycle by detaching CCD 110 when CCD 110 can be used when defective assembly and the like occur.

According to the present embodiment, there is provided such an arrangement that CCD 110 is installed in a substrate (flexible substrate) FL1, and a bonding seat 112 is bonded to the part that comes in succession with the CCD 110, of the substrate FL1. That is, there is provided such an arrangement that the spring member 1112 shown under FIG. 3 urges CCD 110 via the bonding seat 112 and the substrate FL1 so that the spring member 1112 is fixed to the bonding seat 112 with the adhesive while CCD 110 is applied to a front applying surface 1111D of the image sensor holder main body 1111. The spring member 1112 is fixed to the image sensor holder 111 by the CCD plate 113. The CCD plate 113 is provided with the aperture 113A at the portion wherein the back side of CCD 110 is urged by the spring member 1112 that is provided on the back side of the image sensor holder 111. Therefore, when the adhesive is poured in the part of the aperture 113A, the spring member 1112 is fixed on a bonding basis on the bonding seat 112 on the back side of the substrate FL1. Thus, CCD 110 is fixed on the image sensor holder 111.

Thus, the spring member 1112 is fixed on a bonding basis on the bonding seat 112 with the adhesive, so that CCD 110 is mounted in the image sensor holder 111. This structure makes it possible to detach CCD 110 with the substrate FL1 as it is flawless by detaching the bonding seat 112 when trouble is found in assembly. Thus, it is possible to recycle the detached CCD 110 when another product is assembled.

Although details will be described later, according to the present embodiment, in order to suppress shaking of the image sensor holder 111 under the movement, the image sensor holder 111 is urged with the spring member 115 (on FIG. 3) of the vibration isolating unit holder UH2 under Z direction. This feature makes it possible to put aside guide axes G7 and G8 installed in the image sensor holder 111 under a connection hole installed in the slider SL. According to the present embodiment, the point 115A of the spring member 115 of T-like character shown in uppermost FIG. 3 urges a globe BA1 of the image sensor holder main body 1111. This feature makes it possible to suppress shaking under the movement of the image sensor holder 111.

Incidentally, there is provided an arrangement in which LPF (Low Pass Filter) 117 is installed in front of CCD 110, and a lot of parts that compose the LPF 117 are shown in FIG. 3.

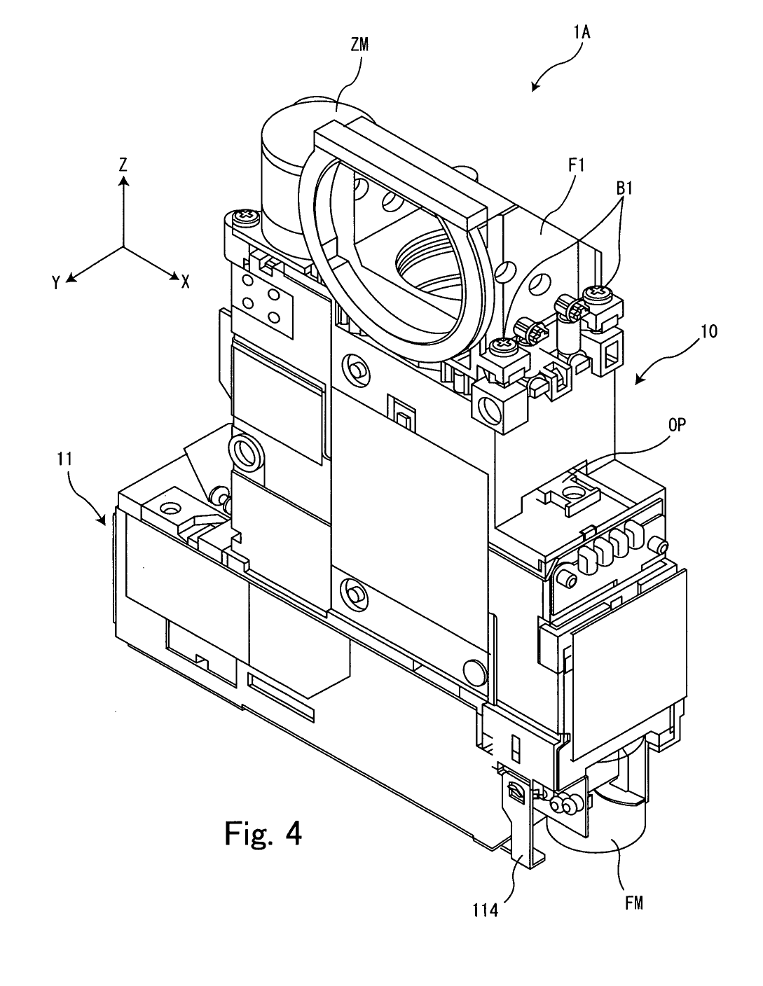

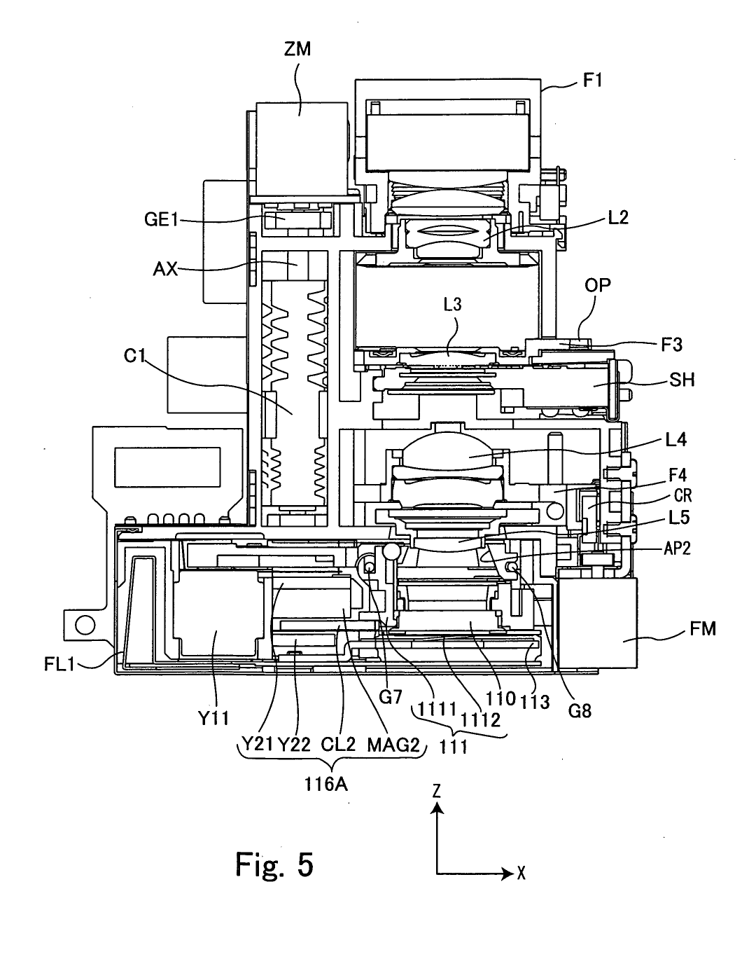

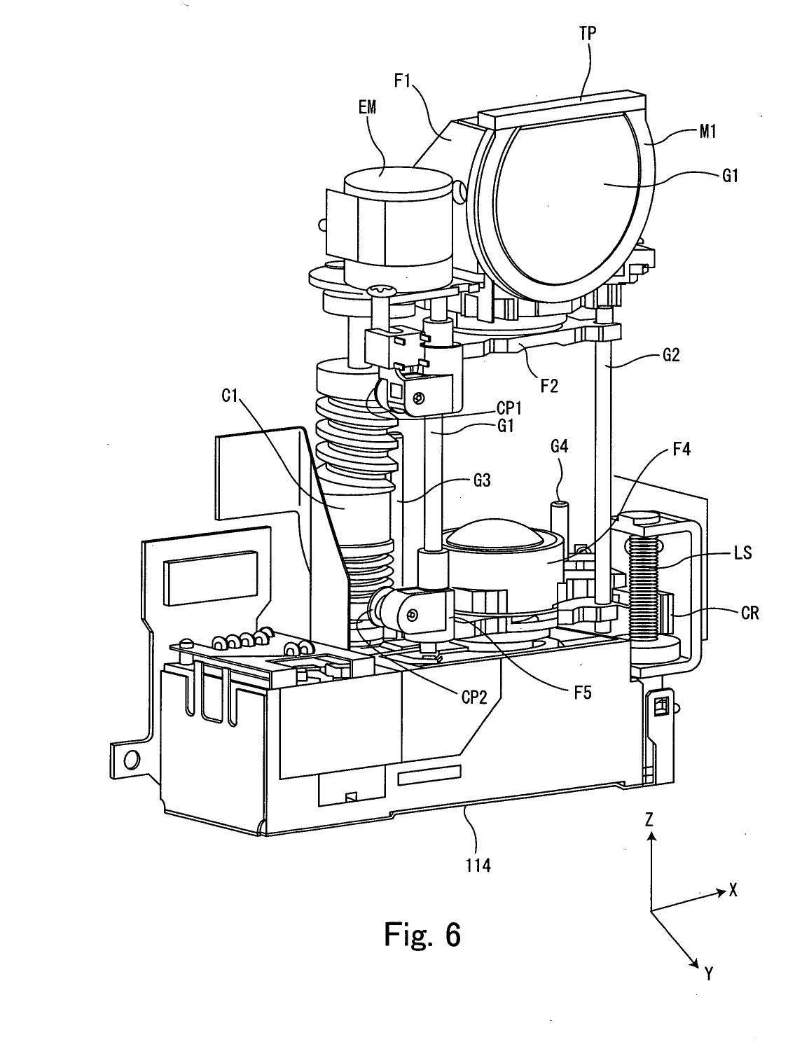

A combination of the lens-barrel unit 10 with the vibration isolating unit 11 by the sheet metal member 114 makes it possible to assemble an image taking unit referred to the present invention reducing the length in Z-direction and the length in Y-direction as shown in FIG. 4, FIG. 5, and FIG. 6.

FIG. 4 is a view showing an image taking unit 1A referred to in the present invention wherein a lens-barrel unit holder UH and a vibration isolating unit holder UH2 are coupled with one another via a sheet metal member 114. FIG. 5 is a sectional view of the image taking unit 1A of FIG. 4 where the image taking unit 1A is cut along the direction of Z with a line parallel to the direction of X to view the cut plane from the front. FIG. 6 is an extraction view wherein portions involved in a second lens group L2, a fifth lens group L5, and a zoom motor ZM, and portions involved in a fourth lens group L4 and a focus motor FM.

Next, there will be explained the composition of the image taking unit 1A referring to FIG. 4, FIG. 5, and FIG. 6.

When the lens-barrel unit 10, in which individual members shown in FIG. 2 are built in the lens-barrel unit holder UH, is coupled by the sheet metal member 114 with the vibration isolating unit 11 in which individual members shown in FIG. 3 are built in the vibration isolating unit holder UH2, it forms the image taking unit 1A shown in FIG. 4 and FIG. 5.

Next, there will be briefly explained the composition of the image taking unit 1A referring to FIG. 4 and FIG. 5.

The lens-barrel unit 10 of the image taking unit 1A shown in FIG. 4 is coupled with the vibration isolating unit 11 in such a state that 1-group frame F1 for holding the first lens group L1 is connected to the side opposite to the side of the vibration isolating unit 11, of the lens-barrel unit 10, and the zoom motor ZM is built in next to 1-group frame F1. The lens-barrel unit holder UH shown in FIG. 2 extends to lower right of the vibration isolating unit 11, wherein the focus motor FM is built in.

As shown in FIG. 5, the second lens group L2 that composes the zoom lens is built in the lens-barrel unit holder UH that is the cover member of the lens-barrel unit 10, and the third lens group L3 that is a fixed lens is built under the second lens group L2 at intervals. The 3-group frame F3 is provided with the operating piece OP as mentioned above. When the operating piece OP (refer to FIG. 4) is operated from the outside, the optical axis adjustment of the optical component on the second optical axis side is performed in conjunction with the machine screw B1 when 1-group frame F1 is connected.

Moreover, as shown in FIG. 5, the fourth lens group L4 that is the focus lens is built in the lens-barrel unit holder UH, and the fifth lens group L5 that composes the zoom lens together with the second lens group L2 is built under the fourth lens group L4. The mechanical shutter SH is built in between the fourth lens group L4 that is the focus lens and the third lens group L3 that is the fixed lens.

On the other hand, the zoom mechanism is built in the side of the bending optical system of the lens-barrel unit holder UH, and there is provided such an arrangement that the cam pins CP1 and CP2 (refer to FIG. 2), which are provided on 2-group frame F1 and 5-group frame F5, respectively, are engaged with the cylindrical cam C1 of the zoom mechanism. In other words, when the cylindrical cam C1 rotates in accordance with rotation of the zoom motor ZM so that the cam pins CP1 and CP2 move in the direction of Z, the interval between the second lens group L2 and the fifth lens group L5 is adjusted to adjust the focal length.

Moreover, there is provided such an arrangement that 4-group frame F4, which is connected via the focus carriage CR to the focus motor FM shown in the right diagonal lower side of FIG. 5, also moves along the second optical axis (Z-direction).

There is provided such an arrangement that fifth lens group L5, which projects from the lens-barrel unit holder UH at the time of the variable power, is accommodated in the aperture AP2 of the slider SL through the aperture AP1 of the vibration isolating unit holder UH2. The X-driving section 116B (Only the yoke Y11 is shown in FIG. 5) is prepared for at the edge in the direction of X of the slider SL. The X-driving section 116B drives the slider SL in the direction of X together with the image sensor holder 111. On the other hand, two Y guide axes G7 and G8 are fixed on the image sensor holder 111 on a press fitting basis, and the slider SL, which moves in the direction of X, supports two Y guide axes G7 and G8 in such a manner that two Y guide axes G7 and G8 are freely movable in Y-direction, so that the Y-driving section 116A drives the image sensor holder 111 in Y-direction. The flexible substrate FL1 drawn out from CCD 110 is provided with such a wiring that there is formed a flexure having a slit in a little free space in the vibration isolating unit 11. Accordingly, a preparation of the flexure permits the image sensor holder 111 to move together with the slider SL in X-direction. In addition, a preparation of the slit (not illustrated) permits the image sensor holder 111 to move in Y-direction.

Next, referring to FIG. 6 there will be explained further in detail the relation among the second lens group L2, the fifth lens group L5, and zoom motor ZM, and the relation between the fourth lens group L4 and the focus motor FM.

As shown in FIG. 6, the cam pin CP1 of 2-group frame F1 for holding the second lens group L2 and the cam pin CP2 of 5-group frame F5 for holding the fifth lens group L5 are engaged with the cylindrical cam C1. With respect to a cam groove of the cylindrical cam C1, a portion with which the cam pin CP1 of the second lens group side is different in pitch from a portion with which the cam pin CP2 of the fifth lens group side, so that mutual interval is adjusted and the focal length is adjusted when the second lens group L2 and the fifth lens group L5 move along their associated pitches, respectively, through rotation. In order to implement a smooth movement of both the lens groups L2 and L5, there are provided two guide shafts G1 and G2 which extend along Z-direction (the second optical axis). Engagement sections K1 to K4 of 2-group frame F1 and 5-group frame F5 are engaged with their associated guide shafts, respectively, so that 2-group frame F1 and 5-group frame F5 move respectively by steady posture.

4-group frame F4 for holding fourth lens group L4 that is the focus lens is so arranged that the carriage is engaged with the lead screw LS to move in Z-direction. At that time, 4-group frame F4 is guided by two guide shafts G3 and G4 so that 4-group frame F4 can move by steady posture. Thus, the movable lens groups such as the zoom lens and the focus lens are compactly accommodated in the lens-barrel unit holder UH on a movable basis.

As mentioned above, according to the present embodiment, in order to shorten the length of the lens-barrel unit 10 and the vibration isolating unit 11 of FIG. 1 in Z-direction, the fifth lens group L5 at the side of the lens-barrel unit 10 is projected from the lens-barrel unit 10, and the apertures AP1 and AP2 for accepting the fifth lens group L5 are prepared at the side of vibration isolating unit 11, so that the lens-barrel unit 10 is readily coupled with the vibration isolating unit 11. The structure will be briefly explained hereinafter.

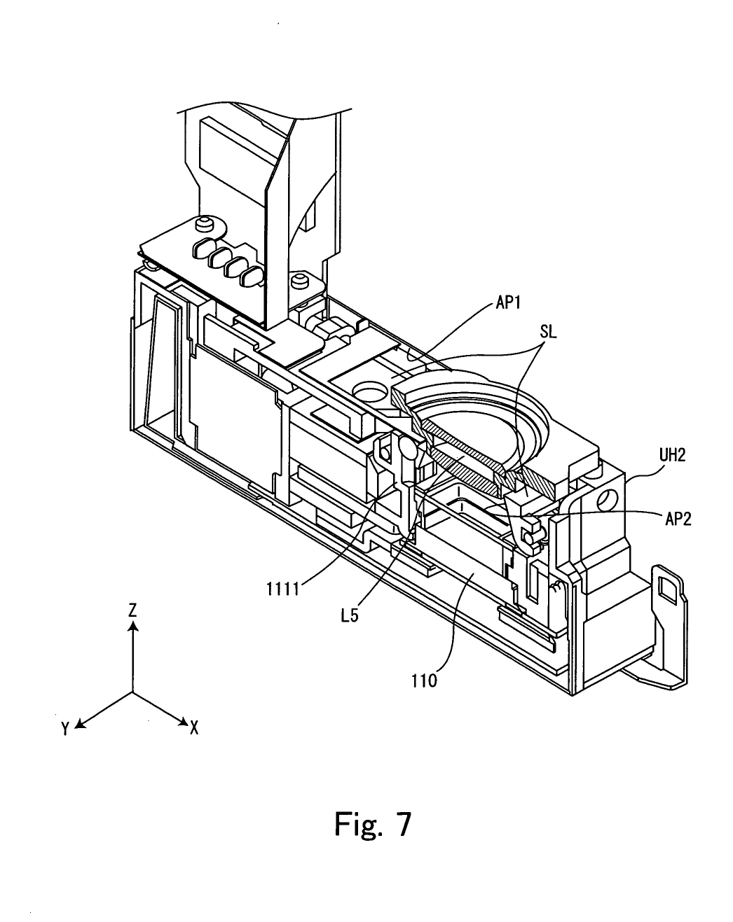

FIG. 7 is an explanatory view useful for understanding a structure of a coupling section for coupling the lens-barrel unit holder and the vibration isolating unit.

FIG. 7 shows the cross-sectional view where the vibration isolating unit 11 is cut along the direction of Z in a parallel line in the direction of X, and the cross section is seen.

According to the present embodiment, as shown in FIG. 7, there is provided such an arrangement that the slider SL is disposed on the vibration isolating unit 11, wherein with respect to the direction of Y, the Y driving section moves directly the image sensor holder 111 in the direction of Y, and with respect to the direction of X, the X driving section moves the slider SL in the direction of X, so that the image sensor holder 111 is moved together with the slider SL in the direction of X. This arrangement makes it possible to dispose the image sensor holder 111 and the slider SL side by side along the second optical axis (Z-direction) of the optical component that projects from the lens-barrel unit 10.

Thus, according to the present embodiment, there is prepared the aperture AP2 on the slider SL of the vibration isolating unit 11 and the slider SL is disposed at the side of the lens-barrel unit 10 rather than the image sensor holder 111, so that the portion projecting from the lens-barrel unit 10 (refer to FIG. 5) is accepted with the aperture of the slider SL. This arrangement makes it possible to locate the optical component (the fifth lens group L5) at an optical axis of the image sensor 110 when the optical component moves to the image sensor side at the time of the variable power.

Next, there will be explained as to how the image sensor holder 111 is supported to the image sensor holder 111 so as to suppress shaking during movement of the image sensor holder 111 in the vibration isolating unit 11, and how X-driving section 116B and Y-driving section 116A are built side by side along X-direction in the vibration isolating unit holder UH2.

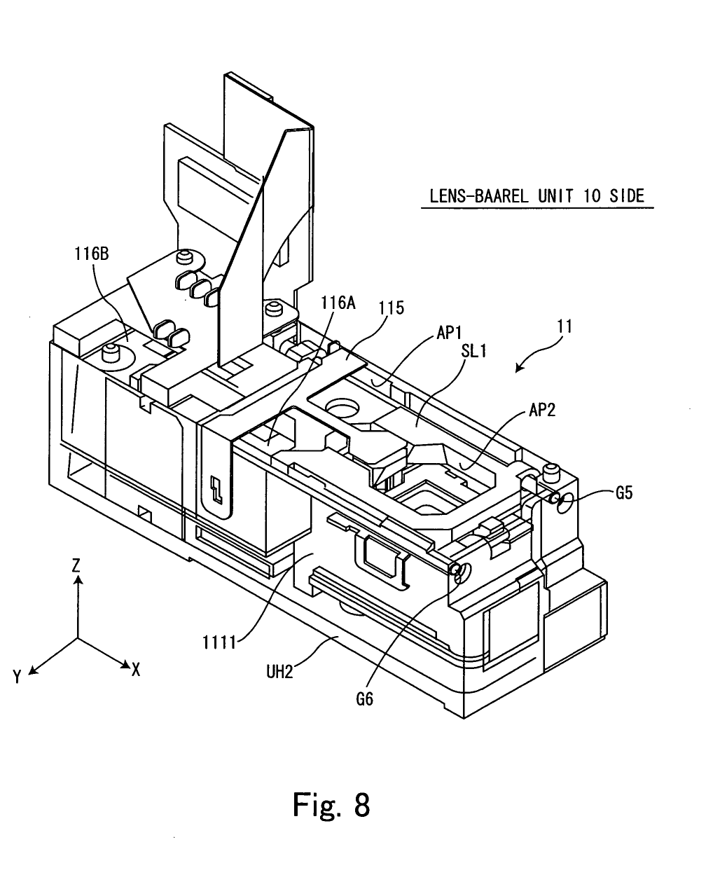

First, while the internal structure of the vibration isolating unit 11 is explained referring to FIG. 8 to FIG. 10, there will be explained as to how X-driving section 116B and Y-driving section 116A are built side by side along X-direction in the vibration isolating unit holder UH2, and then there will be explained as to how shaking during movement of the image sensor is suppressed.

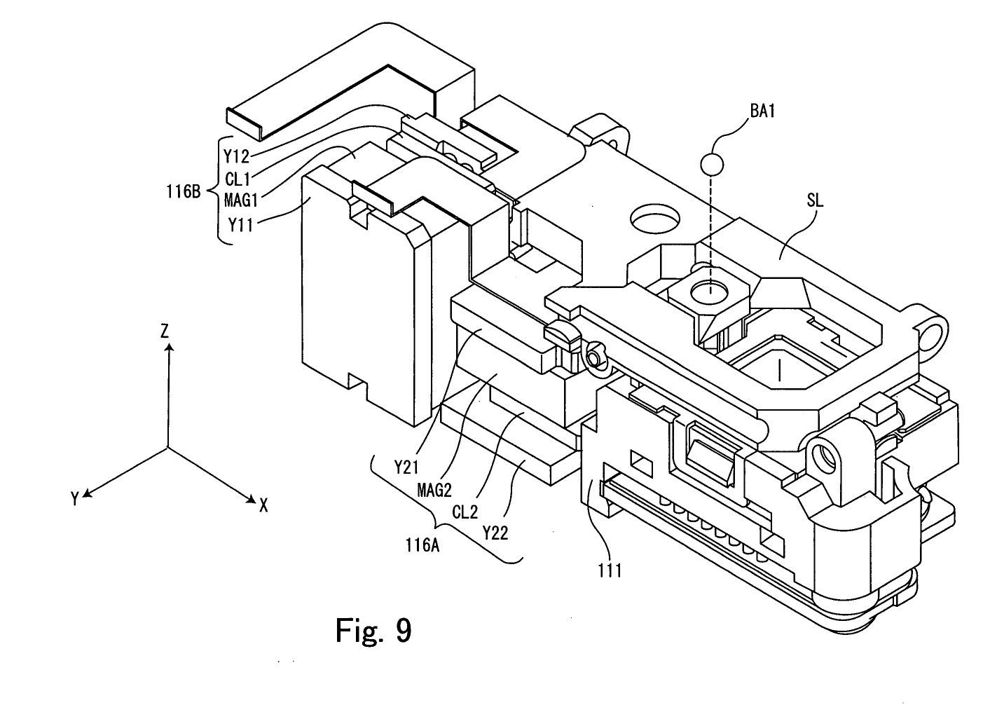

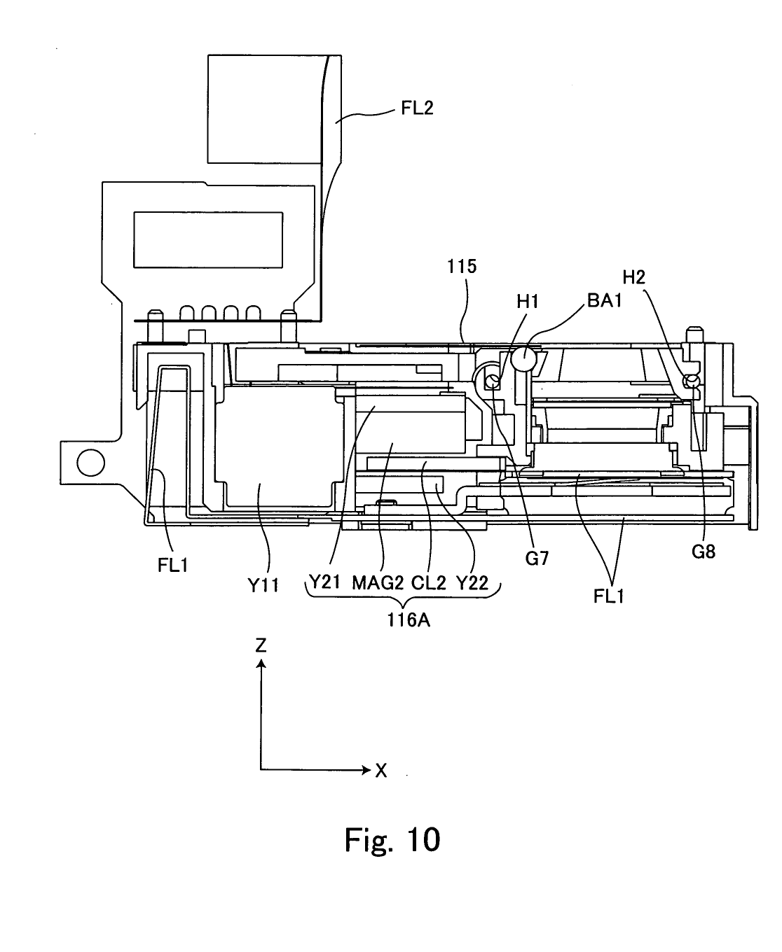

FIG. 8 is a perspective view wherein the state after the vibration isolating unit 11 is built is viewed from the upper side. FIG. 9 is a view wherein the vibration isolating unit holder UH2, which is a case member of the vibration isolating unit 11, and a spring member 115, which is included in the vibration isolating unit holder UH2, are removed to view the inside of the vibration isolating unit 11. FIG. 10 is a sectional view of the vibration isolating unit 11 of FIG. 8 where the vibration isolating unit 11 is cut along the direction of Z with a line parallel to the direction of X to view the cut plane from the front.

First of all, referring to FIG. 8 to FIG. 10, there will be explained as to how X-driving section 116B and Y-driving section 116A are built side by side.

The upper part of FIG. 8 to FIG. 10 forms the lens-barrel unit side.

As mentioned above, according to the present embodiment, there is adopted such an arrangement that X-driving section 116B and Y-driving section 116A are built side by side along X-direction, wherein the X-driving section 116A moves the image sensor holder main body 1111 in Y-direction and Y-driving section 116B moves the slider SL, which is disposed upper the image sensor holder main body 1111, in X-direction, so that CCD 110 is indirectly moved in X-direction.

According to the prior art, the X-driving section 116B and Y-driving section 116A are arranged at the positions along Y-direction and X-direction, respectively, and thus, it is obliged that X-driving section 116A is disposed in Y-direction of the CCD. However, according to the present embodiment, the adoption of the structure shown in FIG. 8 to FIG. 10 makes it possible to provide such an arrangement that the slider SL is disposed upper the image sensor holder 111 for holding CCD extending to X-direction, wherein Y-driving section 116A for driving the image sensor holder 111 is disposed under the slider SL, and then X-driving section 116B is disposed at the position along X-direction of Y-driving section 116A.

Next, there will be explained how the image sensor holder 111 in the vibration isolating unit 11 is supported without very shaking.

According to the present embodiment, as mentioned above, there is proposed such an arrangement that image sensor holder main body 1111 and the slider SL are arranged side by side in Z-direction, and the vibration isolating unit holder UH2 is provided with the spring member 115 shown in FIG. 8 to urge with the spring member 115 a globe BA1 (refer to FIG. 9) of the image sensor holder main body 1111 under the slider, so that shaking during movement of the image sensor 111 is suppressed.

More in detail, as shown in FIG. 10, according to the present embodiment, the spring member 115, which is supported by the vibration isolating unit holder UH2, urges under Z-direction the globe BA1 of the image sensor holder main body 1111, so that shaking during movement of the image sensor 111 is suppressed with the spring member 115. More in detail, the spring member 115 urges the globe BA1 that is disposed at a place which permits the image sensor holder main body 1111 to be effectively pushed down under the vibration isolating unit holder UH2, the place being defined by a range enclosed by two Y guide axes G7 and G8, and X guide axes G5 and G6 that guide the slider SL, so that Y guide axes G7 and G8 of the image sensor holder main body 1111 are put aside under a guide hole H1 and a guide fork H2, respectively, as shown in FIG. 10, which are installed in the slider SL. This arrangement makes it possible to elastically suppress shaking during movement of the image sensor holder main body 1111 by the spring member 115.

Therefore, according to the present embodiment, shaking when the image sensor holder 111 moves to the slider SL is suppressed, and shaking when the slider SL moves to the vibration isolating unit holder UH2 is suppressed to similar.

When the spring member 115 enables the image sensor holder 111 downwards so that the slider SL is enabled downwards through Y guide axes G7 and G8, engagement holes of the slider SL, to which X guide axes G5 and G6 are inserted, respectively, are put aside upper X guide axes G5 and G6 which are fixed on the vibration isolating unit holder UH2.

Therefore, shaking when the image sensor holder 111 moves in the direction of X and the direction of Y is prevented.

Further, according to the present embodiment, such an arrangement that the spring member 115 urges the globe BA1 of the image sensor holder 111 makes it possible to reduce the sliding resistance between the spring member 115 and globe BA1 when the image sensor holder 111 moves in the direction of X and the direction of Y. Incidentally, according to the present embodiment, there is provided such an arrangement that the direction where the globe BA1 is urged with the spring member 115 is the direction along posture in which the digital camera etc. are usually set up when the image sensor holder 111 shown in FIG. 3 to FIG. 10 is disposed to the digital camera etc.

Incidentally, according to the present embodiment, X-driving section 116B and the Y-driving section 116A have each a voice coil motor as a driving source. Accordingly, when X-driving section 116B and Y-driving section 116A are arranged and set, the device is given also to the direction for setting X-driving section 116B and the Y-driving section 116A so that electromagnetic interference should not happen.

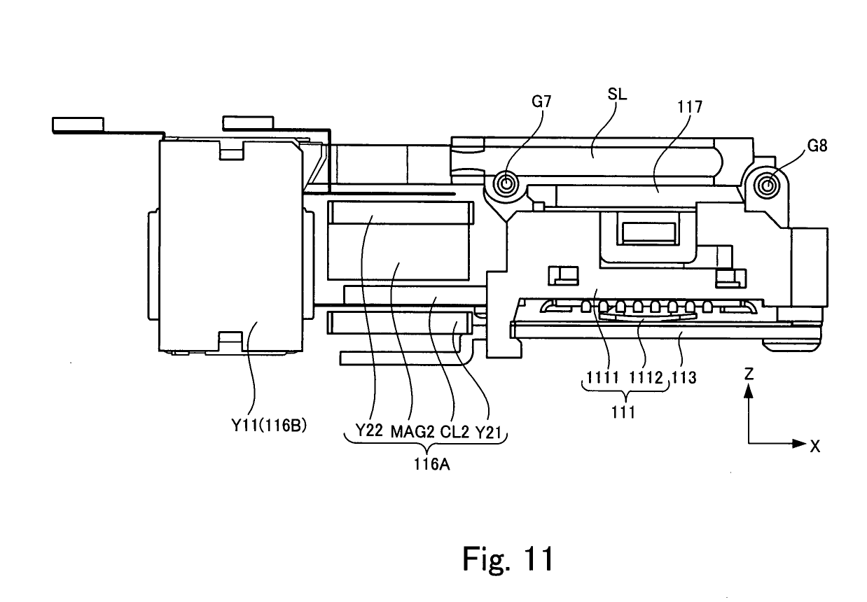

FIG. 11 to FIG. 15 are each a view useful for understanding a difference between the X-driving section and the Y-driving section in a direction of a coil board.

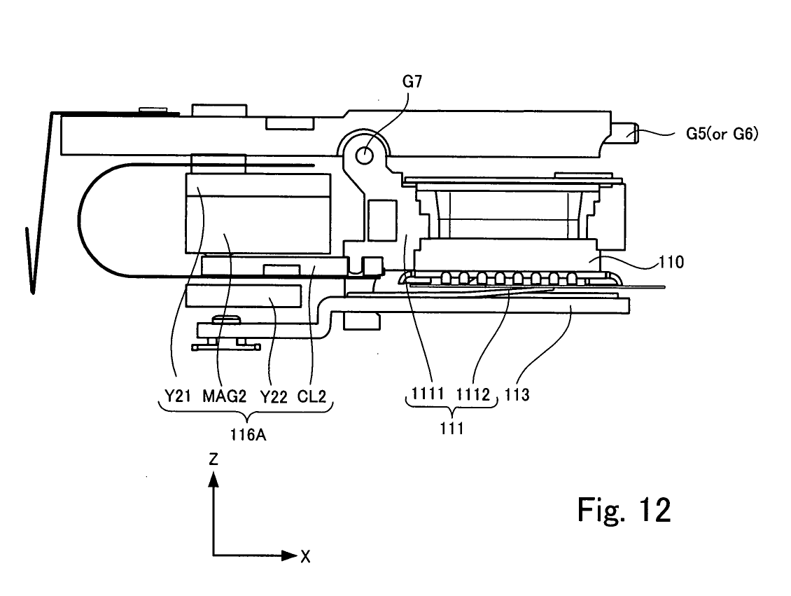

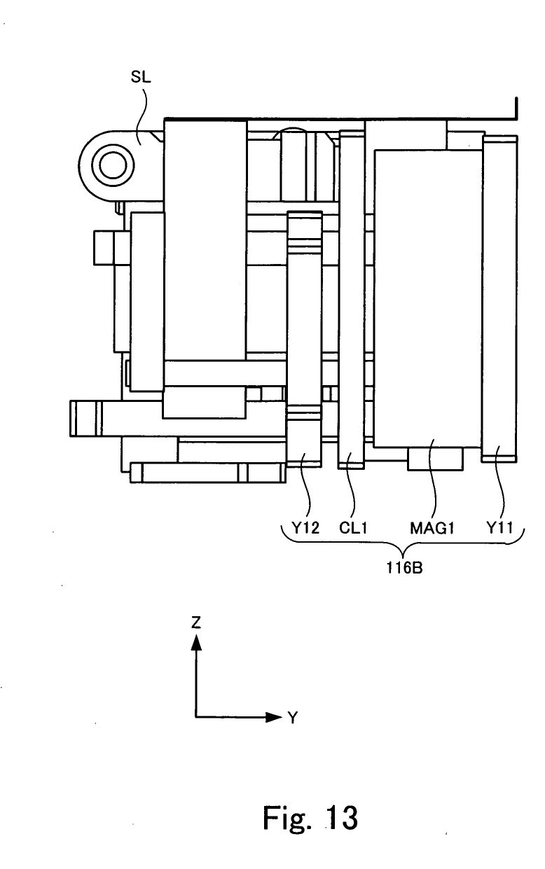

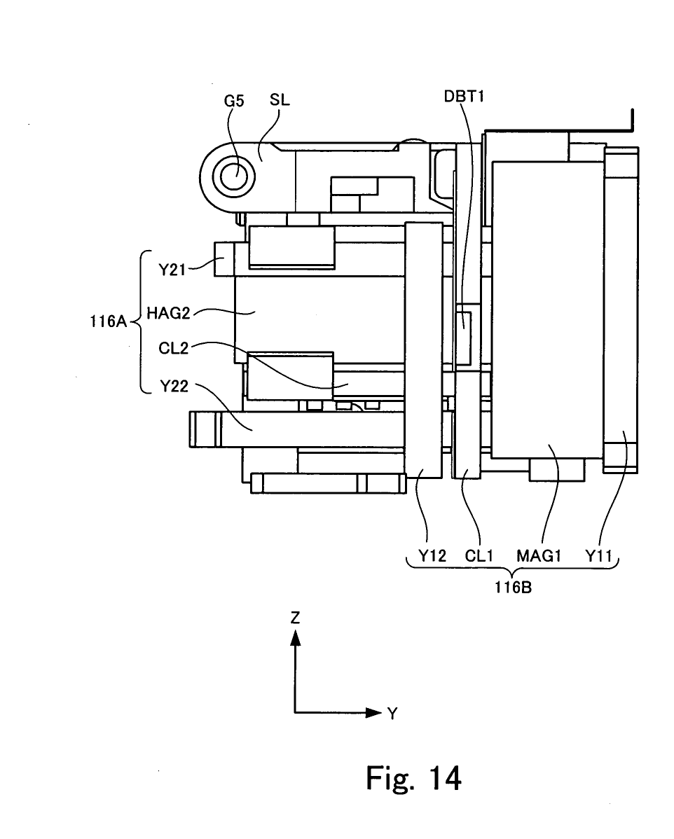

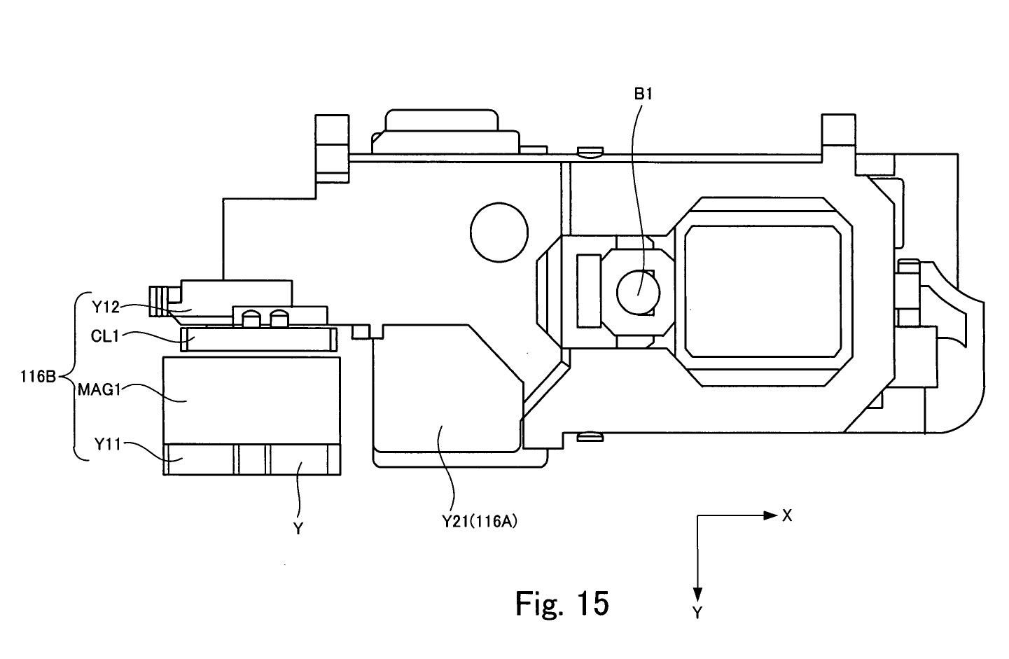

FIG. 11 is a side view of FIG. 9. FIG. 12 is a figure where the X-driving section in FIG. 9 is removed and the inside is seen. FIG. 13 is a figure where the vibration isolating unit in FIG. 11 is seen from the left side of FIG. 11. FIG. 14 is a figure where the part of the Y-driving section 116 in FIG. 11 is cut along the direction of Z with a parallel line to the direction of Y, and the cut respect is viewed from the front. FIG. 15 is a figure where the figure in FIG. 11 is seen from the upper part.

As seen from FIG. 11, there is provided such an arrangement that the slider SL extends along the guide axes G5 and G6 which are supported by the vibration isolating unit holder UH2 (refer to FIG. 8) in the direction of X upper the image sensor holder main body 1111 and the Y-driving section 116A, and the edge reaches the X-driving section 116B. Incidentally, FIG. 11 simply shows yoke Y11 of the X-driving section 116B.

As seen from FIG. 11 and FIG. 12, the Y-driving section 116A, which is located at the position wherein the X-driving section 116B is disposed in the direction of X and on the side of the image sensor holder main body, is coupled via the coil board CL2 with the image sensor holder main body 1111. The image sensor holder main body 1111 is movably supported in the direction of Y by the Y guide axes G7 and G8 which are supported by the slider SL. To clarify the relation between the image sensor holder and the Y-driving section 116A, FIG. 12 shows the positional relation among the image sensor holder main body 1111 of the image sensor holder, the spring member 1112, and the CCD plate 113.

The Y-driving section 116A is provided with the second magnet MAG2 referred to in the present invention and the second coil board CL2 on which there is formed the second coil that generates, upon receipt of a supply of power supply, power to drive the image sensor holder 111 in direction of Y by interaction with the second magnet MAG2. The second coil board CL2 has a hall device DET2 (not illustrated) to detect a position.

As seen from FIG. 13 and FIG. 14, the X-driving section 116B is provided with the first magnet MAG1 referred to in the present invention and the first coil board CL1 on which there is formed the first coil that generates, upon receipt of a supply of power supply, power to drive the image sensor holder 111 in direction of X by interaction with the first magnet MAG1. The first coil board CL1 is coupled with the slider SL. The first coil board CL1 has a hall device DET1 (not illustrated) to detect a position. According to the structure of FIG. 11 to FIG. 14, when the current flows to the second coil, the second coil board CL2 moves in the direction of Y in accordance with Fleming's left-hand rule, and the image sensor holder 111 moves in the direction of Y, and when the current flows to the first coil, the first coil board CL1 moves in the direction of X in accordance with Fleming's left-hand rule, and the image sensor holder 111 moves in the direction of X together with the slider SL.

As mentioned above, the coil boards CL1 and CL2 are magnetically coupled with the magnets MAG1 and MAG2, respectively. Thus, according to the present embodiment, as shown in FIG. 14 and FIG. 15, one coil board CL2 of the first coil board CL1 and the second coil board CL2 is made a substrate looking to the direction of Z and the other coil board CL1 is made a substrate looking to the direction of Y. Thus, it becomes easy for neither the first coil board CL1 nor the second coil board CL2 to receive electromagnetic interference mutually.

Next, there will be explained the structure of the sheet metal member 114 for coupling the lens-barrel unit holder UH with the vibration isolating unit holder UH2.

As mentioned above, according to the present embodiment, there is provided the sheet metal member 114 for coupling the lens-barrel unit 10 with the vibration isolating unit 11 in such a manner that the sheet metal member 114, which extends covering the second surface opposite to the first surface that is to be coupled to the lens-barrel unit 10, of the vibration isolating unit 11, is engaged with the lens-barrel unit holder UH, thereby shortening the length in the direction of Z of the image taking unit 1A where the lens-barrel unit holder UH is coupled with the vibration isolating unit holder UH2.

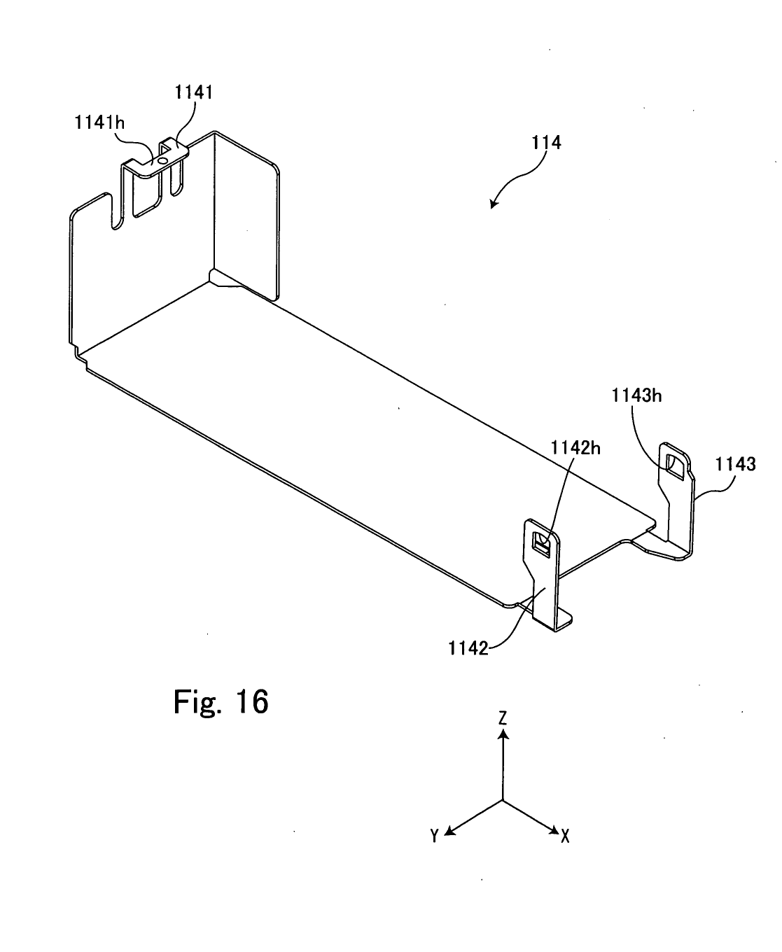

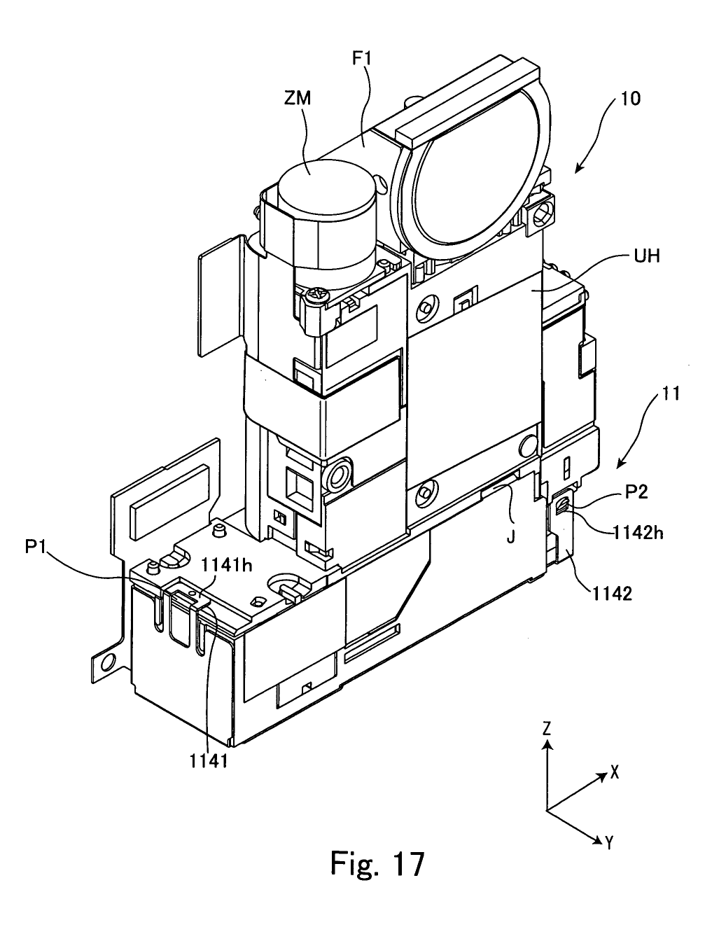

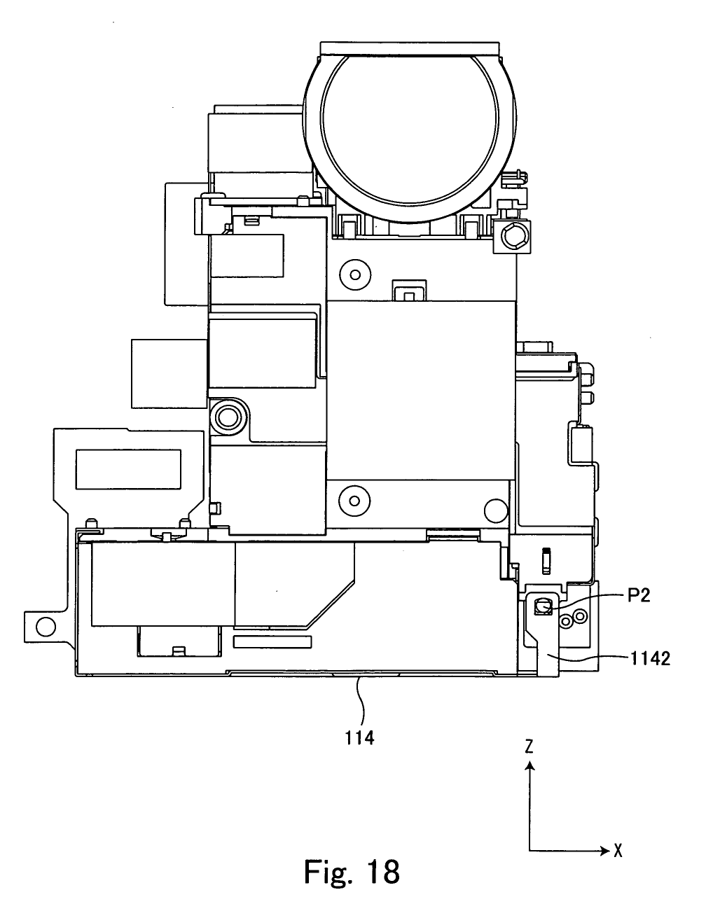

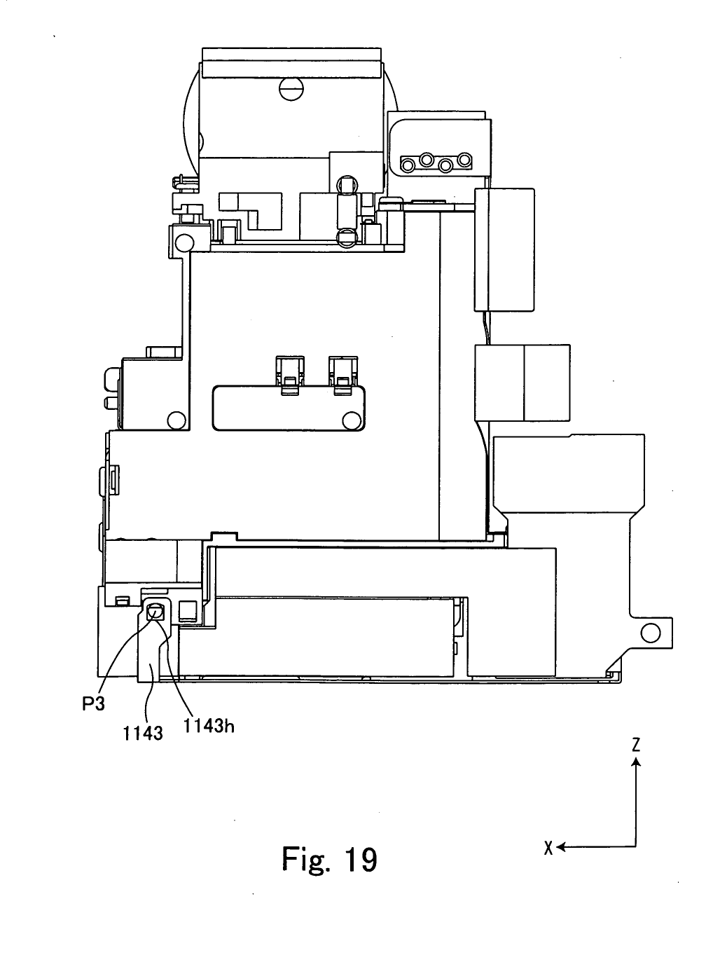

FIG. 16 is an explanatory view useful for understanding a structure of the sheet metal member 114. FIG. 17 is a perspective view of the image taking unit 1A, wherein the lens-barrel unit holder UH and a vibration isolating unit holder UH2 are coupled with one another via the sheet metal member 114, looking from the upper side. FIG. 18 is a front elevation of the image taking unit 1A of FIG. 17. FIG. 19 is a rear elevation of the image taking unit 1A of FIG. 17.

As seen from FIG. 17, the sheet metal member 114 shown in FIG. 16 couples the lens-barrel unit 10 with the vibration isolating unit 11 in such a manner that the sheet metal member 114, which extends covering the second surface opposite to the first surface that is to be coupled to the lens-barrel unit 10, of the vibration isolating unit 11, is engaged with the lens-barrel unit holder UH. At this time, the sheet metal member 114 is engaged with the lens-barrel unit 10 at three points.

According to the present embodiment, there are provided three stopping sections 1141, 1142, and 1143 at both ends of the sheet metal member 114 in the direction of X, respectively. The stopping sections 1141, 1142, and 1143 are each provided with elasticity. The sheet metal member 114 is arranged so as to cover the second surface opposite to the first surface that is to be coupled to the lens-barrel unit 10, whereby height more than the thickness of the sheet metal member 114 is not caused in the direction of Z.

As seen from FIG. 16, the stopping section 1141 of the left end of FIG. 16 is provided with a bend section 1141h directed to a little downward direction of FIG. 16. A projection portion P1 (refer to FIG. 17), which is provided on the lens-barrel unit holder UH, is engaged with the bend section 1141h. The stopping sections 1142 and 1143 are provided with stopping holes 1142h and 1143h, respectively, which are engaged with projections P2 and P3 of the lens-barrel unit holder UH, respectively.

FIG. 17 to FIG. 19 show the state that the vibration isolating unit 11 is coupled with the lens-barrel unit 10 by the sheet metal member 114. FIG. 17 is a perspective view of the image taking unit 1A, looking from the upper side. FIG. 18 is a front elevation of the image taking unit 1A of FIG. 17. FIG. 19 is a rear elevation of the image taking unit 1A of FIG. 17.

As seen from FIG. 17 to FIG. 19, the bend section 1141h of the stopping section is engaged with the projection portion P1 of the lens-barrel unit side, and the stopping holes 1142h and 1143h are engaged with the projections P2 and P3, respectively.

Moreover, as seen from FIG. 17 to FIG. 19, the engagement at three points makes it possible to unite the lens-barrel unit 10 and the vibration isolating unit 11 without the space in such a way that a surface of the sheet metal member 114, which covers the second surface of the vibration isolating unit 11 at the side opposite to the first surface to be coupled with the lens-barrel unit 10, fits to the second surface so as not to cause an extra size in the direction of Z.

According to the arrangement as mentioned above, there is no necessity of the use of the screw when the lens-barrel unit 10 is coupled with the vibration isolating unit 11, and thus it is possible to further shorten the length in the direction of Z.

As mentioned above, after the positional regulation of the vibration isolating unit 11 is performed in the state that the lens-barrel unit 10, which is regulated in optical axis by tightening condition of the machine screw B1 where 1-group frame F1 of FIG. 2 is installed in the lens-barrel unit holder UH, and the operating piece OP of the 3-group frame F3, is coupled with the vibration isolating unit 11 by the sheet metal member 114, three stopping sections 1141, 1142 and 1143 and three projection portions P1, P2 and P3 are fixed by adhesive. Thus, assembly is completed.

Finally, according to the present embodiment, device is given to the structure of the peripheral portion of the image sensor holder 111 and reduction in costs is attempted. Thus, it explains the structure to attempt the reduction in costs.

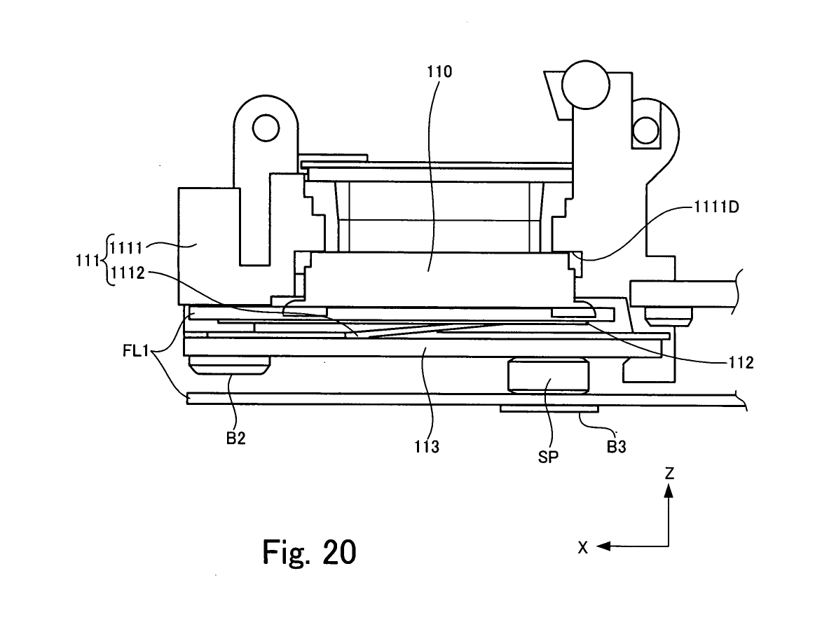

FIG. 20 to FIG. 24 are each a view useful for understanding the improved points.

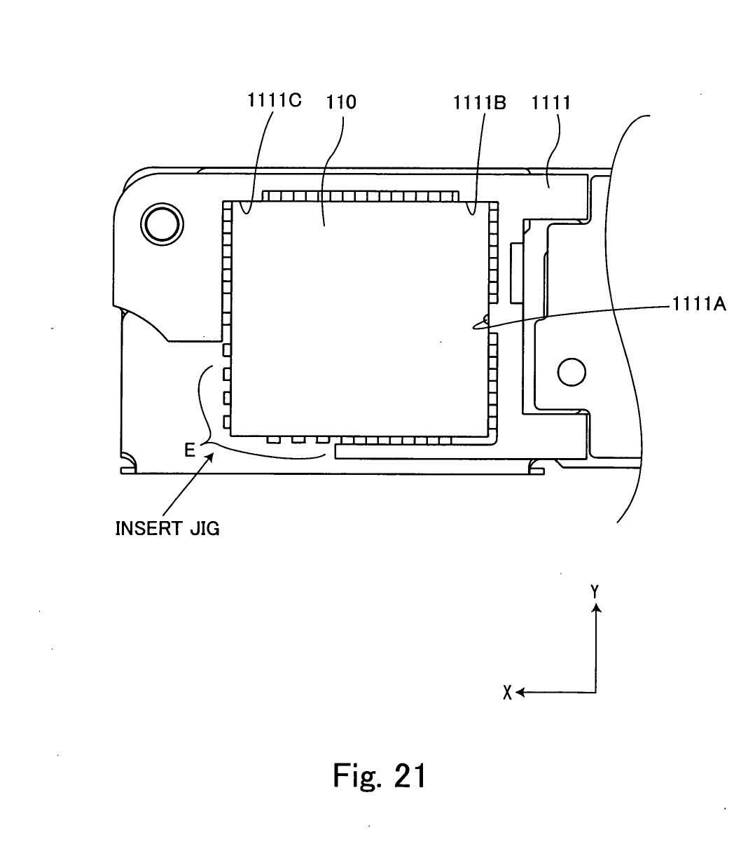

It may be considered to adopt such a structure that a spring member is provided on the image sensor holder main body 1111 so as to enable it to the side of side applying surfaces 1111A to 1111C of FIG. 21. However, this structure involves such a problem that the number of parts around the image sensor holder increases and it becomes an increase in costs. It is also possible to form the spring member integral with the image sensor holder main body 1111. In this case, however, the image sensor holder main body 1111 grows moreover. In view of the foregoing, according to the present embodiment, there is adopted such an arrangement that the assembly jig applies the CCD 110 to the side applying surfaces 1111A to 1111C as shown in FIG. 21, omitting the spring members. This feature makes it possible to contribute to reduction in costs of product and to miniaturizing of the image sensor holder main body 1111.

As mentioned above, according to the present embodiment, taking into consideration such a matter that CCD 110 that is the image sensor is very expensive, there is provided such an arrangement that it is made to recycle by detaching CCD 110 when defective assembly etc. bring about by the assembling process since the process of building CCD 110 into the image sensor holder 111.

Next, referring to FIG. 20 to FIG. 24, there will be explained as to how the spring member for applying is omitted and how to make CCD recycled.

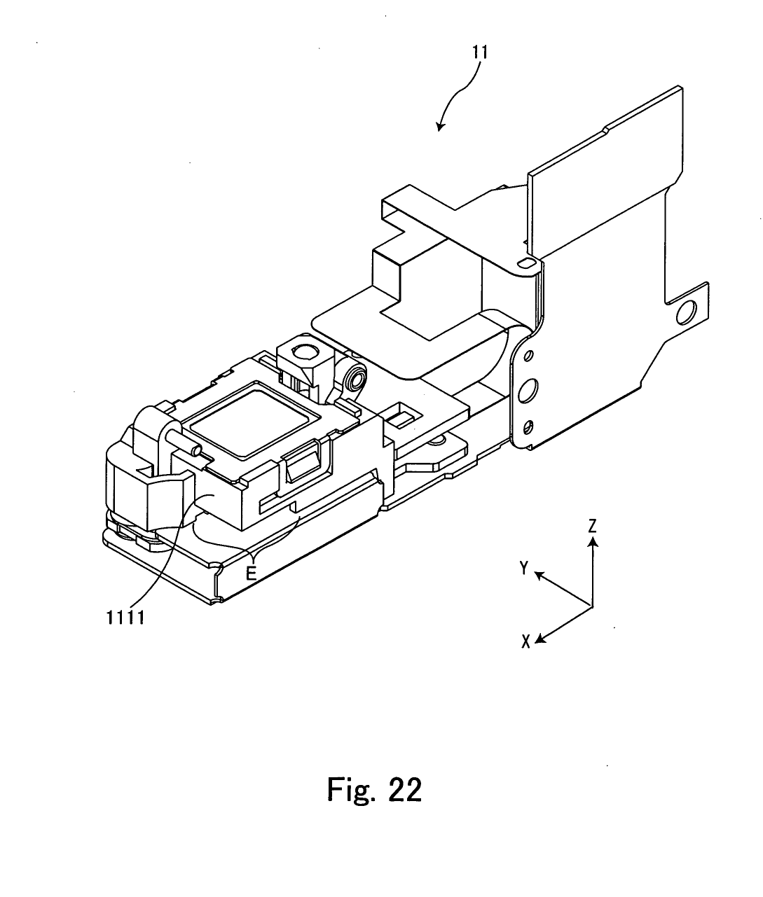

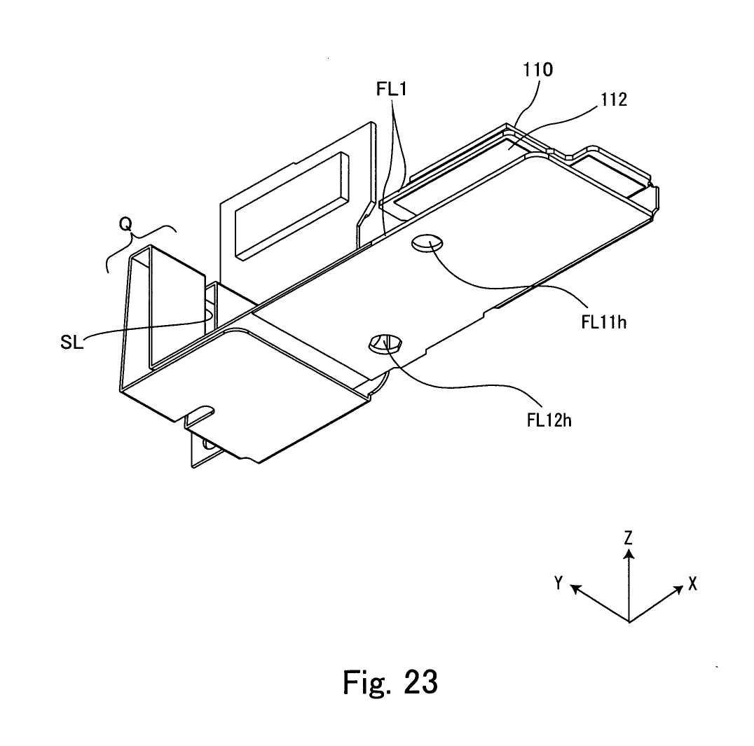

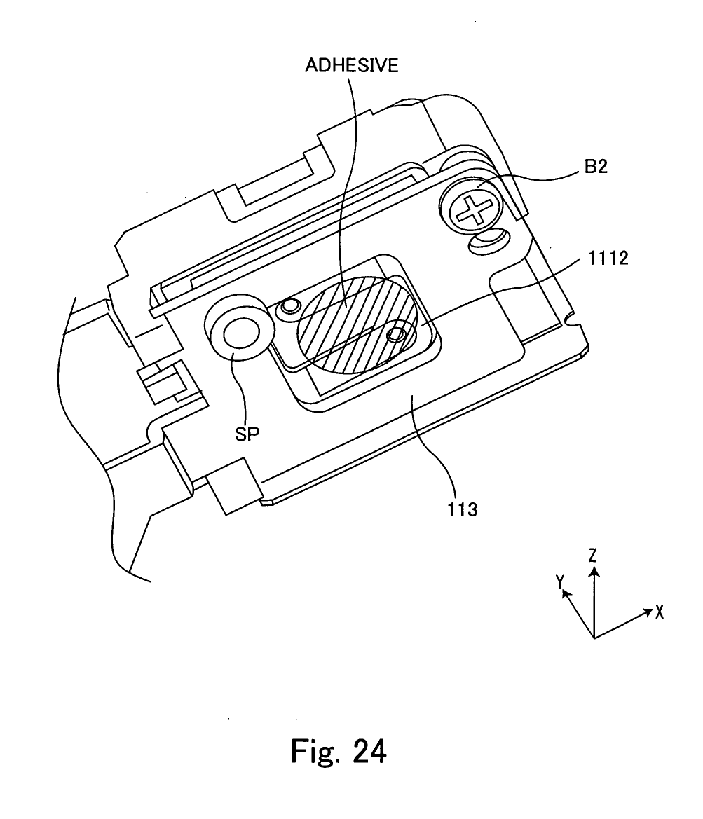

FIG. 20 is a view showing the state that CCD is mounted on an image sensor holder. FIG. 21 is an explanatory view useful for understanding the state that CCD is mounted on the image sensor holder. FIG. 22 is a perspective view of the image sensor holder which mounts CCD. FIG. 23 is a view showing the structure of the substrate that incorporates therein CCD and CCD. FIG. 24 is an explanatory view useful for understanding the state of adhesion that is performed from the back of CCD, after CCD is mounted on the image sensor holder as shown in FIG. 20.

The image sensor holder main body 1111 is provided with the front applying surface 1111D (refer to FIG. 3) to which the light receiving side front edge portion is applied as shown in FIG. 20, and the side applying surfaces 1111A to 1111C to which two sides that are adjacent to a corner in a first corner section, of the CCD 110 as shown in FIG. 21. Moreover, the image sensor holder main body 1111 is provided with a part E where the second corner section in the corner in the first corner section is exposed as shown in FIG. 21 and FIG. 22.

It is acceptable to make the image sensor holder large, and to provide several spring members so as to apply those to the side applying surface. However, according to the present embodiment, there is provided such an arrangement that the CCD 110 is built in the image sensor holder 111 in such a manner that those spring members are omitted, the assembly jig is inserted in the exposed part E, and CCD 110 is installed while CCD 110 is applied to the side applying surface of the image sensor holder 111.

Further, as shown in FIG. 23, taking into consideration such a matter that CCD 110 is loaded on the substrate FL1 beforehand, a bonding seat 112 is bonded to the part that comes in succession with CCD 110 through the substrate FL1.

Here, it explains a method of fixing an image sensor to an image sensor holder referring to FIG. 3 and FIG. 20.

First, CCD 110 is built in the image sensor holder main body 1111. Next, in order to hold CCD 110, the spring member 1112 and the CCD plate 113 are built in the image sensor holder main body 1111 in that order. At that time, a hole 11121h formed on the spring member 1112 and a hole 1131h formed on a CCD plate 113 are engaged with a boss (not illustrated) formed under the image sensor holder main body 1111, and a hole 11122h formed on the spring member 1112 and a hole 1132h formed on the CCD plate 113 are inserted into a screw hole (not illustrated) formed under the image sensor holder main body 1111 and the machine screw B2 is engaged on a spiral basis.

Thus, the spring member 1112 is used to urge CCD 110 via the adhesion sheet and the substrate FL1 so as to apply CCD 110 to the front applying surface 1111D of the image sensor holder main body 1111, so that CCD 110 is installed in the image sensor holder main body 1111. In this condition, CCD 110 is restrained in the position of a direction perpendicular to the imaging plane. However, CCD 110 is movable while enabled by the spring member in a parallel direction to the imaging plane.

Next, as mentioned above, an assembly jig is inserted from a notch exposed portion E so that CCD 110 is held in a state that it is applied to the side applying surfaces 1111A to 1111C. In this state, as shown in FIG. 24, an adhesion sheet 112 and the spring member 1112 are fixed by the adhesive. Thus, the positioning of the image sensor holder main body 1111 to CCD 110 is performed.

Next, as shown in FIG. 23, the substrate FL1 is fixed on CCD plate 113 in a state that it is bent. The flexible substrate FL1 is formed with holes FL11h and FL12h. A machine screw B3 is engaged on a spiral basis with a screw hole 1133h formed on the CCD plate 113 in such a manner that the machine screw B3 is inserted into the hole FL11h and the spacer SP. A machine screw B4 is engaged on a spiral basis with a screw hole 1134h formed on the CCD plate 113 in such a manner that the machine screw B4 is inserted into the hole FL12h. The spacer SP is mounted in order to keep the configuration of the letterform of piece of the substrate FL1 as shown in FIG. 23. Incidentally, the CCD plate 113 is formed with bend having the difference downward on a screw hole 1134h side. Accordingly, no spacer is used in the screw hole 1134h.

As mentioned above, the flexible substrate FL1 is provided with the flexure Q and the slit SL to decrease the stress added at time when the image sensor holder is moved.

This arrangement makes it possible to omit the spring member to be applied to the side applying surfaces 1111A to 1111C of the image sensor holder 111, and also makes it possible to fix CCD 110 on the image sensor holder 111 on an adhesion basis in such a manner that the spring member 1112, which urges CCD 110 to the front applying surface 1111D of the image sensor holder 111, is bonded to the adhesion sheet 112 by the adhesive. This feature makes it possible to contribute to the reduction in costs by the corresponding that the spring member is omitted.

Further, according to the present embodiment, there is no need to prepare a space for accommodating the spring member in the image sensor holder 111. Thus, the image sensor holder 111 can be reduced more than so far, and it is possible to make the shape of the image sensor holder fit externals of CCD. In addition, CCD can be detached while being flawless because the bonding seat may be detached when defective assembly occurs in the process after the image sensor is fixed to the image sensor holder, and it is possible to recycle the detached CCD for assembly of another product.

As mentioned above, according to the embodiments of FIG. 1 to FIG. 24, there are shown examples in which an example of the first driving section referred to in the present invention corresponds to the X driving section, where the first direction referred to in the present invention is denoted by X direction, and the second direction referred to in the present invention is denoted by Y direction, and an example of the second driving section referred to in the present invention corresponds to the Y driving section. However, it is acceptable to provide such an arrangement that there are shown examples in which an example of the first driving section referred to in the present invention corresponds to the Y driving section, where the first direction referred to in the present invention is denoted by Y direction, and the second direction referred to in the present invention is denoted by X direction, and an example of the second driving section referred to in the present invention corresponds to the X driving section.

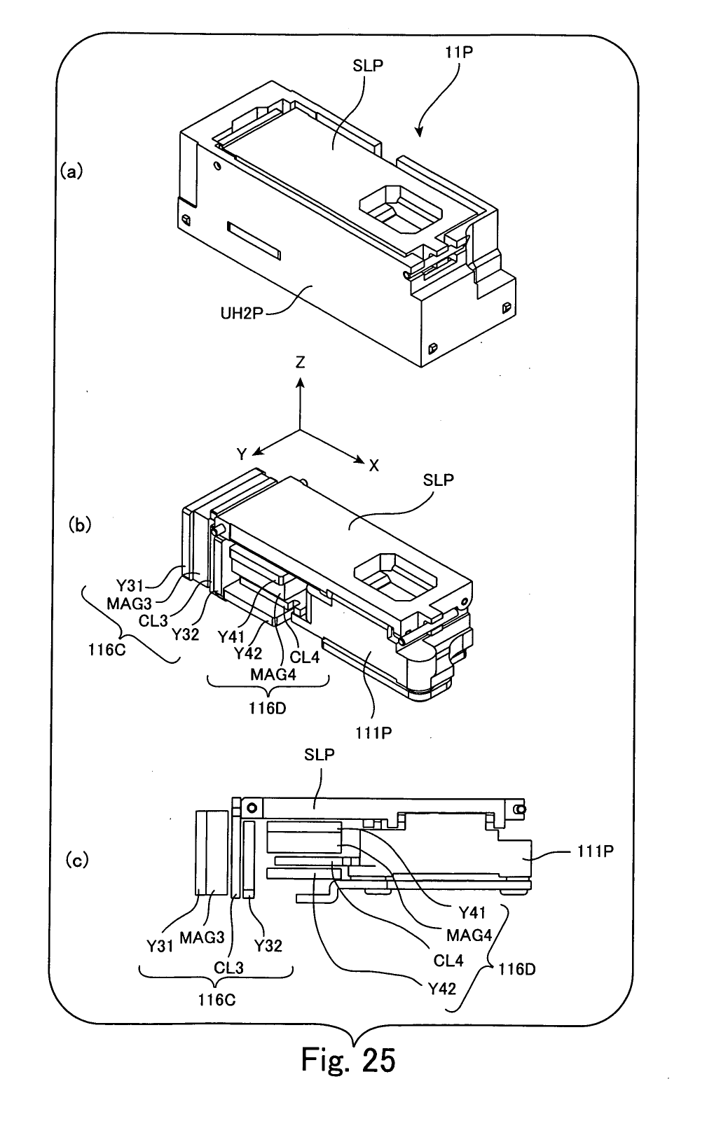

FIG. 25 is an explanatory view useful for understanding another structure of the vibration isolating unit.

A part (a) of FIG. 25 is a perspective view of the vibration isolating unit. A part (b) of FIG. 25 is a structural view of a slider SLP of a vibration isolating unit holder UH2P. A part (c) of FIG. 25 is a side elevation of the slider SLP.

The slider SLP shown in FIG. 25 is supported movably in Y direction in the vibration isolating unit holder UH2P of a vibration isolating unit 11P. Y driving section 116C for driving the slider SLP in Y direction is disposed at the left end of the vibration isolating unit 11P shown in the part (b) of FIG. 25 and the part (c) of FIG. 25. Y driving section 116C is composed of a voice coil motor that consists of magnet MAG3, yoke Y31, coil CL3, and yoke Y32. Between the Y driving section 116C and a image sensor holder 111P, there is disposed X driving section 116D for driving in X direction the image sensor holder 111P supported movably in X direction to the slider SLP. The X driving section 116D is composed of a voice coil motor that consists of magnet MAG4, yoke Y41, coil CL4, and yoke Y42.

Thus, an arrangement of the Y driving section 116C, which constitutes an example of the first driving section referred to in the present invention, and the X driving section 116D, which constitutes an example of the second driving section referred to in the present invention, at the place of the vibration isolating unit holder UH2P in X direction, as shown in the part (b) of FIG. 25 and the part (c) of FIG. 25, makes it also possible to contribute reduction of the size of the vibration isolating unit holder UH2P in Y direction.

As mentioned above, according to the present invention, it is possible to implement a vibration isolating unit that is suitably loaded on a digital camera contributing to reducing the thickness of the body through adoption of the bending optical system, an image taking unit having the vibration isolating unit, and an image taking apparatus having the image taking unit.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A vibration isolating unit that is coupled with a lens-barrel unit including a bending optical system which turns a subject light incident along a first optical axis extending in Y-direction toward the subject to a direction along a second optical axis extending in Z-direction perpendicular to Y-direction so as to make image-formation, and that includes an image sensor for creating an image signal representing the subject through image-formation of the subject light by the bending optical system and moves the image sensor so that the vibration isolating unit suppresses blurring on the image signal, the vibration isolating unit comprising:
a vibration isolating unit holder which is a case of the vibration isolating unit;
a slider that has a first guide axis supported by the vibration isolating unit holder, the first guide axis being extended in a first direction which is one of the Y-direction and X-direction perpendicular to both Y-direction and Z-direction, the slider being freely movable in the first direction;
an image sensor holder that holds the image sensor and has a second guide axis supported by the slider, the second guide axis being extended in a second direction which is another different from the first direction, of the X-direction and the Y-direction, the image sensor holder being freely movable in the second direction;
a second driving section that moves the image sensor holder in the second direction, the second driving section being disposed at a place aligned in the X-direction with the image sensor holder; and
a first driving section that moves the slider together with the image sensor holder in the first direction, the first driving section being disposed at a place aligned in the X-direction with the second driving section.

2. The vibration isolating unit according to claim 1, wherein
the first driving section has a first magnet and a first coil board on which there is formed a first coil that generates a driving force to drive the slider in the first direction by interaction with the first magnet upon receipt of a supply of power supply, and
the second driving section has a second magnet and a second coil board on which there is formed a second coil that generates a driving force to drive the image sensor holder in the second direction by interaction with the second magnet upon receipt of a supply of power supply.

3. The vibration isolating unit according to claim 2, wherein the first coil board and the second coil board are arranged so as to be perpendicular to one another.

4. An image taking that has a lens-barrel unit including a bending optical system wherein a subject light incident along a first optical axis extending in Y-direction toward the subject to a direction along a second optical axis extending in Z-direction perpendicular to Y-direction so as to make image-formation, and that has a vibration isolating unit including an image sensor for creating an image signal representing the subject through image-formation of the subject light by the bending optical system and moves the image sensor so that the vibration isolating unit suppresses blurring on the image signal, wherein the vibration isolating unit comprises:
a vibration isolating unit holder which is a case of the vibration isolating unit;
a slider that has a first guide axis supported by the vibration isolating unit holder, the first guide axis being extended in a first direction which is one of the Y-direction and X-direction perpendicular to both Y-direction and Z-direction, the slider being freely movable in the first direction;
an image sensor holder that holds the image sensor and has a second guide axis supported by the slider, the second guide axis being extended in a second direction which is another different from the first direction, of the X-direction and the Y-direction, the image sensor holder being freely movable in the second direction;
a second driving section that moves the image sensor holder in the second direction, the second driving section being disposed at a place aligned in the X-direction with the image sensor holder; and
a first driving section that moves the slider together with the image sensor holder in the first direction, the first driving section being disposed at a place aligned in the X-direction with the second driving section.

5. An image taking apparatus having the image taking unit as defined in claim 4, wherein the image taking apparatus generates an image signal in which blurring is reduced by operation of the vibration isolating unit constituting the image taking unit.
